(19) United States
(12) Patent Application Publication
(10) Pub. No.: US 2025/0192863 A1
(43) Pub. Date: Jun. 12, 2025

(54) BEAM PREDICTION MODES SWITCHING IN WIRELESS COMMUNICATION

(71) Applicant: QUALCOMM Incorporated, San Diego, CA (US)

(72) Inventors: Tianyang BAI, Mountain View, CA (US); Mahmoud TAHERZADEH BOROUJENI, San Diego, CA (US); Qiaoyu LI, Beijing (CN); Hamed PEZESHKI, San Diego, CA (US); Hua WANG, Basking Ridge, NJ (US); Wooseok NAM, San Diego, CA (US); Mohamed Fouad Ahmed MARZBAN, San Diego, CA (US); Junyi LI, Greentown, PA (US); Taesang YOO, San Diego, CA (US); Tao LUO, San Diego, CA (US); Yan ZHOU, San Diego, CA (US)

(21) Appl. No.: 18/846,158

(22) PCT Filed: May 6, 2022
(86) PCT No.: PCT/CN2022/091107

§ 371 Date: Sep. 11, 2024

(51) Int. Cl. H04B 7/06; H04W 24/08

(52) U.S. Cl. CPC H04B 7/06952; H04W 24/08

(57) ABSTRACT

Aspects of the present disclosure disclose techniques and apparatuses for beam prediction and configuration of a beam prediction module. Beam prediction can reduce overhead and latency in wireless communication. A wireless communication device can select one or more beams based on beam prediction or beam measurements. A wireless apparatus can communicate with a network entity using a first beam set. The wireless apparatus can communicate with the network entity using a second beam set that is predicted using a beam prediction model based on at least in part the first beam set. The wireless apparatus can change the beam prediction model in response to a change of a prediction condition that includes at least one of a discontinuous reception (DRX) mode of the UE, a change in UE mobility, a prediction error of the beam prediction model, or an interference level.

### TECHNICAL FIELD

The technology discussed below relates generally to wireless communication systems, and more particularly, to beam prediction and switching between beam prediction modes.

### INTRODUCTION

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems. These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. Some wireless communications systems (e.g., NR systems) may use beamforming techniques for communications between wireless devices. Beamforming may be used to improve signal quality and overcome path losses in these systems.

### BRIEF SUMMARY OF SOME EXAMPLES

The following presents a summary of one or more aspects of the present disclosure, in order to provide a basic understanding of such aspects. This summary is not an extensive overview of all contemplated features of the disclosure, and is intended neither to identify key or critical elements of all aspects of the disclosure nor to delineate the scope of any or all aspects of the disclosure. Its sole purpose is to present some concepts of one or more aspects of the disclosure in a form as a prelude to the more detailed description that is presented later.

One aspect of the disclosure provides a method of wireless communication at a user equipment (UE). The UE communicates with a network entity using a first beam set. The UE communicates with the network entity using a second beam set that is predicted using a beam prediction model based on at least in part the first beam set. The UE reconfigures the beam prediction model in response to a change of a prediction condition that comprises at least one of a discontinuous reception (DRX) mode of the UE, a change in UE mobility, a prediction error of the beam prediction model, or an interference level.

One aspect of the disclosure provides a user equipment (UE) for wireless communication. The UE includes a transceiver for communication with a network entity, a memory, and a processor coupled to the transceiver and the memory. The processor and the memory are configured to communicate with the network entity using a first beam set. The processor and the memory are configured to communicate with the network entity using a second beam set that is predicted using a beam prediction model based on at least in part the first beam set. The processor and the memory are configured to reconfigure the beam prediction model in response to a change of a prediction condition that includes at least one of a discontinuous reception (DRX) mode of the UE, a change in UE mobility, a prediction error of the beam prediction model, or an interference level.

One aspect of the disclosure provides a UE for wireless communication. The UE includes means for communicating with a network entity using a first beam set. The UE further includes means for communicating with the network entity using a second beam set that is predicted using a beam prediction model based on at least in part the first beam set. The UE further includes means for reconfiguring the beam prediction model in response to a change of a prediction condition that comprises at least one of a discontinuous reception (DRX) mode of the UE, a change in UE mobility, a prediction error of the beam prediction model, or an interference level.

One aspect of the disclosure provides a computer-readable storage medium stored with executable code for wireless communication. The executable code includes instructions that cause a UE to communicate with a network entity using a first beam set. The instructions further cause a UE to communicate with the network entity using a second beam set that is predicted using a beam prediction model based on at least in part the first beam set. The instructions further cause a UE to reconfigure the beam prediction model in response to a change of a prediction condition that comprises at least one of a discontinuous reception (DRX) mode of the UE, a change in UE mobility, a prediction error of the beam prediction model, or an interference level.

One aspect of the disclosure provides a method of wireless communication at a network entity. The network entity communicates with a UE using a first beam set. The network entity communicates with the UE using a second beam set that is predicted using a beam prediction model based on at least in part the first beam set. The network entity reconfigures the beam prediction model in response to a change of a prediction condition that includes at least one of a discontinuous reception (DRX) mode of the UE, a change in UE mobility, a prediction error of the beam prediction model, or an interference level.

One aspect of the disclosure provides a network entity of a wireless communication network. The network entity includes a memory and a processor coupled to the memory. The processor and the memory are configured to communicate with a UE using a first beam set. The processor and the memory are further configured to communicate with the UE using a second beam set that is predicted using a beam prediction model based on at least in part the first beam set. The processor and the memory are further configured to reconfigure the beam prediction model in response to a change of a prediction condition that includes at least one of a discontinuous reception (DRX) mode of the UE, a change in UE mobility, a prediction error of the beam prediction model, or an interference level.

One aspect of the disclosure provides a network entity of a wireless communication network. The network entity includes means for communicating with a UE using a first beam set. The network entity further includes means for communicating with the UE using a second beam set that is predicted using a beam prediction model based on at least in part the first beam set. The network entity further includes means for reconfiguring the beam prediction model in response to a change of a prediction condition that comprises at least one of a discontinuous reception (DRX) mode of the UE, a change in UE mobility, a prediction error of the beam prediction model, or an interference level.

One aspect of the disclosure provides a computer-readable storage medium stored with executable code for wireless communication. The executable code includes instructions that cause a network entity to communicate with a UE using a first beam set. The instructions further cause the network entity to communicate with the UE using a second beam set that is predicted using a beam prediction model based on at least in part the first beam set. The instructions further cause the network entity to reconfigure the beam prediction model in response to a change of a prediction condition that comprises at least one of a discontinuous reception (DRX) mode of the UE, a change in UE mobility, a prediction error of the beam prediction model, or an interference level.

These and other aspects of the invention will become more fully understood upon a review of the detailed description, which follows. Other aspects, features, and implementations will become apparent to those of ordinary skill in the art, upon reviewing the following description of specific, exemplary implementations in conjunction with the accompanying figures. While features may be discussed relative to certain examples and figures below, all implementations can include one or more of the advantageous features discussed herein. In other words, while one or more implementations may be discussed as having certain advantageous features, one or more of such features may also be used in accordance with the various examples discussed herein. In a similar fashion, while examples may be discussed below as device, system, or method implementations, it should be understood that such examples can be implemented in various devices, systems, and methods.

### BRIEF DESCRIPTION OF THE DRAWINGS

FIG. 1 is a schematic illustration of a wireless communication system according to some aspects.

FIG. 2 is an illustration of an exemplary radio access network (RAN) according to some aspects.

FIG. 3. is a schematic illustration of an exemplary disaggregated base station architecture.

FIG. 4 is a schematic illustration of an organization of wireless resources in an air interface utilizing orthogonal frequency divisional multiplexing (OFDM) according to some aspects.

FIG. 5 is a block diagram illustrating a wireless communication system supporting multiple-input multiple-output (MIMO) communication.

FIG. 6 is a diagram illustrating communication between a network entity and a UE using beamformed signals according to some aspects.

FIG. 7 is a diagram illustrating an exemplary channel state information (CSI) resource mapping according to some aspects.

FIG. 8 is a signaling diagram illustrating exemplary signaling between wireless devices to provide channel state information feedback (CSF) within a wireless network according to some aspects.

FIG. 9 is a block diagram illustrating a beam prediction model for beam prediction according to some aspects.

FIG. 10 is a block diagram illustrating a beam prediction function implementation for beam prediction according to some aspects.

FIG. 11 is a diagram illustrating a first implementation of beam prediction at a network entity according to some aspects.

FIG. 12 is a diagram illustrating a second implementation of beam prediction at a user equipment (UE) according to some aspects.

FIG. 13 is a diagram illustrating a third implementation of beam prediction at both a network entity and a UE according to some aspects.

FIG. 14 is a flow chart illustrating an exemplary process for performing beam prediction according to some aspects.

FIG. 15 is a flow chart illustrating an exemplary process for determining types of events causing a mode switching of a beam prediction model according to some aspects.

FIG. 16 is a diagram illustrating an example of switching between modes of a beam prediction model based on a discontinuous reception (DRX) configuration according to some aspects.

FIG. 17 is a block diagram conceptually illustrating an example of a hardware implementation for a user equipment according to some aspects.

FIG. 18 is a flow chart illustrating an exemplary process for wireless communication using beam prediction at a UE according to some aspects.

FIG. 19 is a block diagram conceptually illustrating an example of a hardware implementation for a network entity according to some aspects of the disclosure.

FIG. 20 is a flow chart illustrating an exemplary process for wireless communication using beam prediction at a network entity according to some aspects.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well-known structures and components are shown in block diagram form in order to avoid obscuring such concepts.

While aspects and implementations are described in this application by illustration to some examples, those skilled in the art will understand that additional implementations and use cases may come about in many different arrangements and scenarios. Innovations described herein may be implemented across many differing platform types, devices, systems, shapes, sizes, and packaging arrangements. For example, implementations and/or uses may come about via integrated chips and other non-module-component based devices (e.g., end-user devices, vehicles, communication devices, computing devices, industrial equipment, retail/purchasing devices, medical devices, AI-enabled devices, etc.). While some examples may or may not be specifically directed to use cases or applications, a wide assortment of applicability of described innovations may occur. Implementations may range a spectrum from chip-level or modular components to non-modular, non-chip-level implementations and further to aggregate, distributed, or OEM devices or systems incorporating one or more aspects of the described innovations. In some practical settings, devices incorporating described aspects and features may also necessarily include additional components and features for implementation and practice of claimed and described examples. For example, transmission and reception of wireless signals necessarily includes a number of components for analog and digital purposes (e.g., hardware components including antenna, RF-chains, power amplifiers, modulators, buffer, processor(s), interleaver, adders/summers, etc.). It is intended that innovations described herein may be practiced in a wide variety of devices, chip-level components, systems, distributed arrangements, disaggregated arrangements (e.g., base station and UE), end-user devices, etc. of varying sizes, shapes and constitution.

Aspects of the present disclosure disclose techniques and apparatuses for beam prediction and configuration of a beam prediction module. In some aspects, wireless devices can be configured to use beamforming for wireless communication. However, one or more active beam pairs between two wireless devices may become misaligned, which may result in beam and/or communication failures. Thus, improved beam management techniques may be desired. In some scenarios, a wireless communication device can select one or more beams based on beam prediction or beam measurements. Beam prediction can reduce overhead and latency in wireless communication.

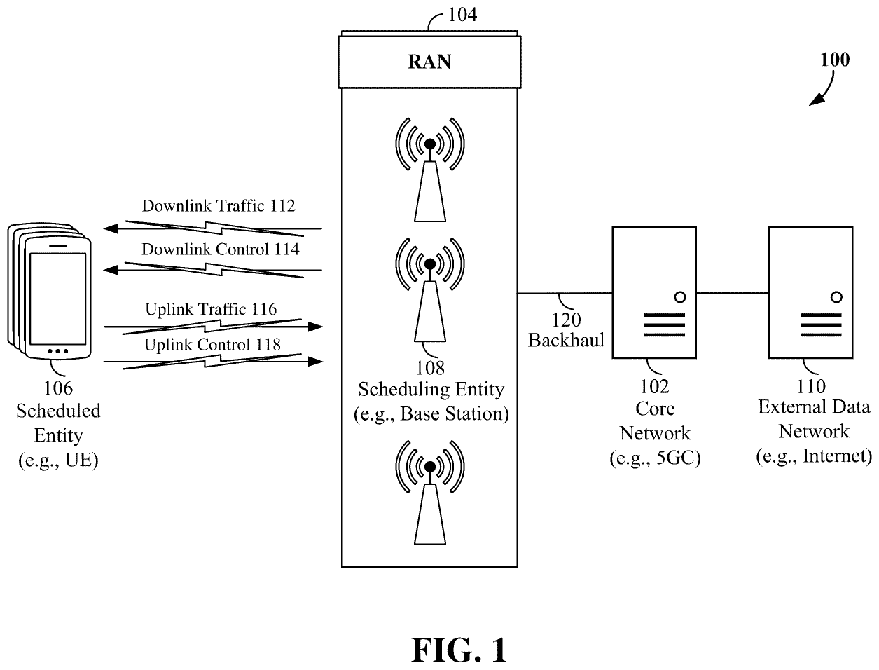

The various concepts presented throughout this disclosure may be implemented across a broad variety of telecommunication systems, network architectures, and communication standards. Referring now to FIG. 1, as an illustrative example without limitation, various aspects of the present disclosure are illustrated with reference to a wireless communication system 100. The wireless communication system 100 includes three interacting domains: a core network 102, a radio access network (RAN) 104, and a user equipment (UE) 106. By virtue of the wireless communication system 100, the UE 106 may be enabled to carry out data communication with an external data network 110, such as (but not limited to) the Internet.

The RAN 104 may implement any suitable wireless communication technology or technologies to provide radio access to the UE 106. As one example, the RAN 104 may operate according to 3^{rd} Generation Partnership Project (3GPP) New Radio (NR) specifications, often referred to as 5G. As another example, the RAN 104 may operate under a hybrid of 5G NR and Evolved Universal Terrestrial Radio Access Network (eUTRAN) standards, often referred to as Long-Term Evolution (LTE). The 3GPP refers to this hybrid RAN as a next-generation RAN, or NG-RAN. Of course, many other examples may be utilized within the scope of the present disclosure.

As illustrated, the RAN 104 includes a plurality of network entities (e.g., base stations 108). Broadly, a base station is a network element in a radio access network responsible for radio transmission and reception in one or more cells to or from a UE. In different technologies, standards, or contexts, a base station may variously be referred to by those skilled in the art as a base transceiver station (BTS), a radio base station, a radio transceiver, a transceiver function, a basic service set (BSS), an extended service set (ESS), an access point (AP), a Node B (NB), an eNode B (eNB), a gNode B (gNB), a transmission and reception point (TRP), or some other suitable terminology. In some examples, a base station may include two or more TRPs that may be collocated or non-collocated. Each TRP may communicate on the same or different carrier frequency within the same or different frequency band.

The RAN 104 is further illustrated supporting wireless communication for multiple mobile apparatuses. A mobile apparatus may be referred to as user equipment (UE) in 3GPP standards, but may also be referred to by those skilled in the art as a mobile station (MS), a subscriber station, a mobile unit, a subscriber unit, a wireless unit, a remote unit, a mobile device, a wireless device, a wireless communications device, a remote device, a mobile subscriber station, an access terminal (AT), a mobile terminal, a wireless terminal, a remote terminal, a handset, a terminal, a user agent, a mobile client, a client, or some other suitable terminology. A UE may be an apparatus (e.g., a mobile apparatus) that provides a user with access to network services.

Within the present document, a “mobile” apparatus need not necessarily have a capability to move, and may be stationary. The term mobile apparatus or mobile device broadly refers to a diverse array of devices and technologies. UEs may include a number of hardware structural components sized, shaped, and arranged to help in communication; such components can include antennas, antenna arrays, RF chains, amplifiers, one or more processors, etc. electrically coupled to each other. For example, some non-limiting examples of a mobile apparatus include a mobile, a cellular (cell) phone, a smart phone, a session initiation protocol (SIP) phone, a laptop, a personal computer (PC), a notebook, a netbook, a smartbook, a tablet, a personal digital assistant (PDA), and a broad array of embedded systems, e.g., corresponding to an “Internet of things” (IoT). A mobile apparatus may additionally be an automotive or other transportation vehicle, a remote sensor or actuator, a robot or robotics device, a satellite radio, a global positioning system (GPS) device, an object tracking device, a drone, a multi-copter, a quad-copter, a remote control device, a consumer and/or wearable device, such as eyewear, a wearable camera, a virtual reality device, a smart watch, a health or fitness tracker, a digital audio player (e.g., MP3 player), a camera, a game console, etc. A mobile apparatus may additionally be a digital home or smart home device such as a home audio, video, and/or multimedia device, an appliance, a vending machine, intelligent lighting, a home security system, a smart meter, etc. A mobile apparatus may additionally be a smart energy device, a security device, a solar panel or solar array, a municipal infrastructure device controlling electric power (e.g., a smart grid), lighting, water, etc.; an industrial automation and enterprise device; a logistics controller; agricultural equipment, etc. Still further, a mobile apparatus may provide for connected medicine or telemedicine support, e.g., health care at a distance. Telehealth devices may include telehealth monitoring devices and telehealth administration devices, whose communication may be given preferential treatment or prioritized access over other types of information, e.g., in terms of prioritized access for transport of critical service data, and/or relevant QoS for transport of critical service data.

Wireless communication between a RAN 104 and a UE 106 may be described as utilizing an air interface. Transmissions over the air interface from a network entity (e.g., base station 108) to one or more UEs (e.g., UE 106) may be referred to as downlink (DL) transmission. In accordance with certain aspects of the present disclosure, the term downlink may refer to a point-to-multipoint transmission originating at a scheduling entity (described further below; e.g., base station 108). Another way to describe this scheme may be to use the term broadcast channel multiplexing. Transmissions from a UE (e.g., UE 106) to a network entity (e.g., base station 108) may be referred to as uplink (UL) transmissions. In accordance with further aspects of the present disclosure, the term uplink may refer to a point-to-point transmission originating at a scheduled entity (described further below; e.g., UE 106).

In some examples, access to the air interface may be scheduled, wherein a scheduling entity (e.g., a base station 108) allocates resources for communication among some or all devices and equipment within its service area or cell. Within the present disclosure, as discussed further below, the scheduling entity may be responsible for scheduling, assigning, reconfiguring, and releasing resources for one or more scheduled entities. That is, for scheduled communication, UEs 106, which may be scheduled entities, may utilize resources allocated by the scheduling entity 108.

Base stations 108 are not the only entities that may function as scheduling entities. That is, in some examples, a UE may function as a scheduling entity, scheduling resources for one or more scheduled entities (e.g., one or more other UEs).

As illustrated in FIG. 1, a network entity (e.g., scheduling entity 108) may broadcast downlink traffic 112 to one or more scheduled entities 106. Broadly, the scheduling entity 108 is a node or device responsible for scheduling traffic in a wireless communication network, including the downlink traffic 112 and, in some examples, uplink traffic 116 from one or more scheduled entities 106 to the scheduling entity 108. On the other hand, the scheduled entity 106 is a node or device that receives downlink control information 114, including but not limited to scheduling information (e.g., a grant), synchronization or timing information, or other control information from another entity in the wireless communication network such as the scheduling entity 108. The scheduled entity 106 may further transmit uplink control information 118, including but not limited to a scheduling request or feedback information, or other control information to the scheduling entity 108.

In addition, the uplink and/or downlink control information 114 and/or 118 and/or traffic information 112 and/or 116 may be transmitted on a waveform that may be time-divided into frames, subframes, slots, and/or symbols. As used herein, a symbol may refer to a unit of time that, in an orthogonal frequency division multiplexed (OFDM) waveform, carries one resource element (RE) per sub-carrier. A slot may carry 7 or 14 OFDM symbols. A subframe may refer to a duration of 1 ms. Multiple subframes or slots may be grouped together to form a single frame or radio frame. Within the present disclosure, a frame may refer to a predetermined duration (e.g., 10 ms) for wireless transmissions, with each frame consisting of, for example, 10 subframes of 1 ms each. Of course, these definitions are not required, and any suitable scheme for organizing waveforms may be utilized, and various time divisions of the waveform may have any suitable duration.

In general, base stations 108 may include a backhaul interface for communication with a backhaul portion 120 of the wireless communication system. The backhaul 120 may provide a link between a base station 108 and the core network 102. Further, in some examples, a backhaul network may provide interconnection between the respective base stations 108. Various types of backhaul interfaces may be employed, such as a direct physical connection, a virtual network, or the like using any suitable transport network.

The core network 102 may be a part of the wireless communication system 100, and may be independent of the radio access technology used in the RAN 104. In some examples, the core network 102 may be configured according to 5G standards (e.g., 5GC). In other examples, the core network 102 may be configured according to a 4G evolved packet core (EPC), or any other suitable standard or configuration.

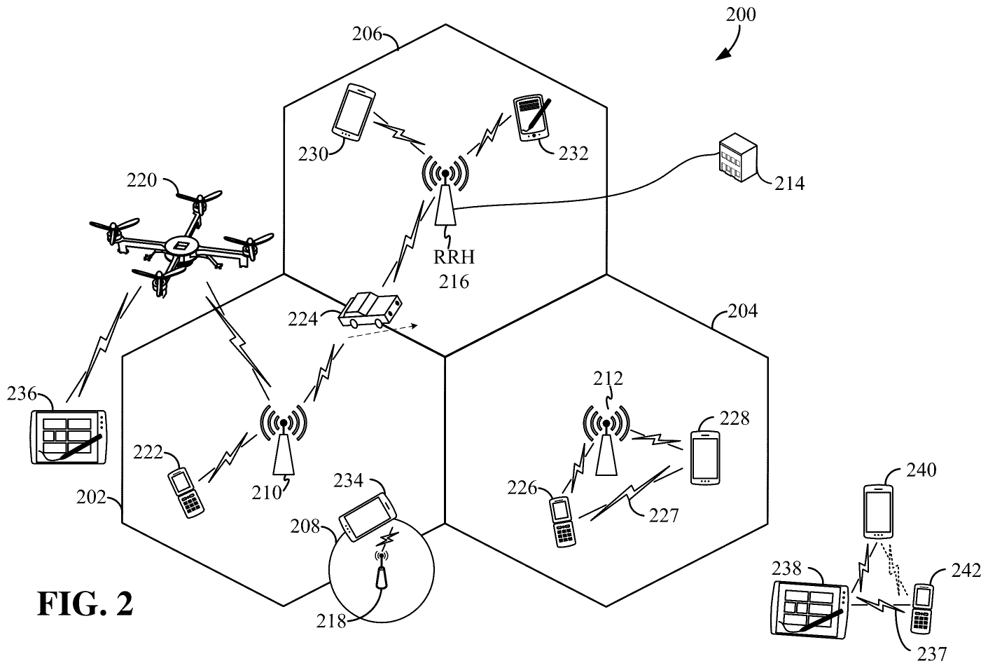

Referring now to FIG. 2, by way of example and without limitation, a schematic illustration of a RAN 200 is provided. In some examples, the RAN 200 may be the same as the RAN 104 described above and illustrated in FIG. 1. The geographic area covered by the RAN 200 may be divided into cellular regions (cells) that can be uniquely identified by a user equipment (UE) based on an identification broadcasted from one access point or base station. FIG. 2 illustrates cells 202, 204, 206, and 208, each of which may include one or more sectors (not shown). A sector is a sub-area of a cell. All sectors within one cell are served by the same base station. A radio link within a sector can be identified by a single logical identification belonging to that sector. In a cell that is divided into sectors, the multiple sectors within a cell can be formed by groups of antennas with each antenna responsible for communication with UEs in a portion of the cell.

Various base station arrangements can be utilized. For example, in FIG. 2, two base stations, base station 210 and base station 212 are shown in cells 202 and 204. A third base station, base station 214 is shown controlling a remote radio head (RRH) 216 in cell 206. That is, a base station can have an integrated antenna or can be connected to an antenna or RRH 216 by feeder cables. In the illustrated example, cells 202, 204, and 206 may be referred to as macrocells, as the base stations 210, 212, and 214 support cells having a large size. Further, a base station 218 is shown in the cell 208, which may overlap with one or more macrocells. In this example, the cell 208 may be referred to as a small cell (e.g., a microcell, picocell, femtocell, home base station, home Node B, home eNode B, etc.), as the base station 218 supports a cell having a relatively small size. Cell sizing can be done according to system design as well as component constraints.

It is to be understood that the radio access network 200 may include any number of wireless base stations and cells. Further, a relay node may be deployed to extend the size or coverage area of a given cell. The base stations 210, 212, 214, 218 provide wireless access points to a core network for any number of mobile apparatuses. In some examples, the base stations 210, 212, 214, and/or 218 may be the same as the base station/scheduling entity 108 described above and illustrated in FIG. 1.

FIG. 2 further includes an unmanned aerial vehicle (UAV) 220, which may be a quadcopter or drone. The UAV 220 may be configured to function as a base station. That is, in some examples, a cell may not necessarily be stationary, and the geographic area of the cell may move according to the location of a mobile base station such as the quadcopter 220.

Within the RAN 200, the cells may include UEs that may be in communication with one or more sectors of each cell. Further, each base station 210, 212, 214, 218, and 220 may be configured to provide an access point to a core network 102 (see FIG. 1) for all the UEs in the respective cells. For example, UEs 222 and 224 may be in communication with base station 210; UEs 226 and 228 may be in communication with base station 212; UEs 230 and 232 may be in communication with base station 214 by way of RRH 216; UE 234 may be in communication with base station 218; and UE 236 may be in communication with mobile base station 220. In some examples, the UEs 222, 224, 226, 228, 230, 232, 234, 236, 238, 240, and/or 242 may be the same as the UE/scheduled entity 106 described above and illustrated in FIG. 1.

In some examples, the UAV 220 (e.g., quadcopter) may be configured to function as a UE. For example, the UAV 220 may operate within cell 202 by communicating with base station 210.

In a further aspect of the RAN 200, sidelink signals may be used between UEs without necessarily relying on scheduling or control information from a base station. Sidelink communication may be utilized, for example, in a device-to-device (D2D) network, peer-to-peer (P2P) network, vehicle-to-vehicle (V2V) network, vehicle-to-everything (V2X) network, and/or other suitable sidelink network. For example, two or more UEs (e.g., UEs 238, 240, and 242) may communicate with each other using sidelink signals 237 without relaying that communication through a base station. In some examples, the UEs 238, 240, and 242 may each function as a scheduling entity or transmitting sidelink device and/or a scheduled entity or a receiving sidelink device to schedule resources and communicate sidelink signals 237 therebetween without relying on scheduling or control information from a base station. In other examples, two or more UEs (e.g., UEs 226 and 228) within the coverage area of a base station (e.g., base station 212) may also communicate sidelink signals 227 over a direct link (sidelink) without conveying that communication through the base station 212. In this example, the base station 212 may allocate resources to the UEs 226 and 228 for the sidelink communication.

In some examples, a D2D relay framework may be included within a cellular network to facilitate relaying of communication to/from the base station 212 via D2D links (e.g., sidelinks 227 or 237). For example, one or more UEs (e.g., UE 228) within the coverage area of the base station 212 may operate as relaying UEs to extend the coverage of the base station 212, improve the transmission reliability to one or more UEs (e.g., UE 226), and/or to allow the base station to recover from a failed UE link due to, for example, blockage or fading.

In the RAN 200, the ability for a UE to communicate while moving, independent of its location, is referred to as mobility. The various physical channels between the UE and the radio access network are generally set up, maintained, and released under the control of an access and mobility management function (AMF, not illustrated, part of the core network 102 in FIG. 1), which may include a security context management function (SCMF) and a security anchor function (SEAF) that perform authentication. The SCMF can manage, in whole or in part, the security context for both the control plane and the user plane functionality.

In various aspects of the disclosure, a RAN 200 may utilize DL-based mobility or UL-based mobility to enable mobility and handovers (i.e., the transfer of a UE's connection from one radio channel to another). In a network configured for DL-based mobility, during a call with a scheduling entity, or at any other time, a UE may monitor various parameters of the signal from its serving cell as well as various parameters of neighboring cells. Depending on the quality of these parameters, the UE may maintain communication with one or more of the neighboring cells. During this time, if the UE moves from one cell to another, or if signal quality from a neighboring cell exceeds that from the serving cell for a given amount of time, the UE may undertake a handoff or handover from the serving cell to the neighboring (target) cell. For example, UE 224 (illustrated as a vehicle, although any suitable form of UE may be used) may move from the geographic area corresponding to its serving cell 202 to the geographic area corresponding to a neighbor cell 206. When the signal strength or quality from the neighbor cell 206 exceeds that of its serving cell 202 for a given amount of time, the UE 224 may transmit a reporting message to its serving base station 210 indicating this condition. In response, the UE 224 may receive a handover command, and the UE may undergo a handover to the cell 206.

In a network configured for UL-based mobility, UL reference signals from each UE may be utilized by the network to select a serving cell for each UE. In some examples, the base stations 210, 212, and 214/216 may broadcast unified synchronization signals (e.g., unified Primary Synchronization Signals (PSSs), unified Secondary Synchronization Signals (SSSs) and unified Physical Broadcast Channels (PBCH)). The UEs 222, 224, 226, 228, 230, and 232 may receive the unified synchronization signals, derive the carrier frequency and slot timing from the synchronization signals, and in response to deriving timing, transmit an uplink pilot or reference signal. The uplink pilot signal transmitted by a UE (e.g., UE 224) may be concurrently received by two or more cells (e.g., base stations 210 and 214/216) within the radio access network 200. Each of the cells may measure a strength of the pilot signal, and the radio access network (e.g., one or more of the base stations 210 and 214/216 and/or a central node within the core network) may determine a serving cell for the UE 224. As the UE 224 moves through the radio access network 200, the network may continue to monitor the uplink pilot signal transmitted by the UE 224. When the signal strength or quality of the pilot signal measured by a neighboring cell exceeds that of the signal strength or quality measured by the serving cell, the network 200 may handover the UE 224 from the serving cell to the neighboring cell, with or without informing the UE 224.

Although the synchronization signal transmitted by the base stations 210, 212, and 214/216 may be unified, the synchronization signal may not identify a particular cell, but rather may identify a zone of multiple cells operating on the same frequency and/or with the same timing. The use of zones in 5G networks or other next generation communication networks enables the uplink-based mobility framework and improves the efficiency of both the UE and the network, since the number of mobility messages that need to be exchanged between the UE and the network may be reduced.

In various implementations, the air interface in the RAN 200 may utilize licensed spectrum, unlicensed spectrum, or shared spectrum. Licensed spectrum provides for exclusive use of a portion of the spectrum, generally by virtue of a mobile network operator purchasing a license from a government regulatory body. Unlicensed spectrum provides for shared use of a portion of the spectrum without need for a government-granted license. While compliance with some technical rules is generally still required to access unlicensed spectrum, generally, any operator or device may gain access. Shared spectrum may fall between licensed and unlicensed spectrum, wherein technical rules or limitations may be required to access the spectrum, but the spectrum may still be shared by multiple operators and/or multiple RATs. For example, the holder of a license for a portion of licensed spectrum may provide licensed shared access (LSA) to share that spectrum with other parties, e.g., with suitable licensee-determined conditions to gain access.

The air interface in the RAN 200 may utilize one or more duplexing algorithms. Duplex refers to a point-to-point communication link where both endpoints can communicate with one another in both directions. Full-duplex means both endpoints can simultaneously communicate with one another. Half-duplex means only one endpoint can send information to the other at a time. Half-duplex emulation is frequently implemented for wireless links utilizing time division duplex (TDD). In TDD, transmissions in different directions on a given channel are separated from one another using time division multiplexing. That is, at some times the channel is dedicated for transmissions in one direction, while at other times the channel is dedicated for transmissions in the other direction, where the direction may change very rapidly, e.g., several times per slot. In a wireless link, a full-duplex channel generally relies on physical isolation of a transmitter and receiver, and suitable interference cancellation technologies. Full-duplex emulation is frequently implemented for wireless links by utilizing frequency division duplex (FDD) or spatial division duplex (SDD). In FDD, transmissions in different directions may operate at different carrier frequencies (e.g., within paired spectrum). In SDD, transmissions in different directions on a given channel are separated from one another using spatial division multiplexing (SDM). In other examples, full-duplex communication may be implemented within unpaired spectrum (e.g., within a single carrier bandwidth), where transmissions in different directions occur within different sub-bands of the carrier bandwidth. This type of full-duplex communication may be referred to herein as sub-band full duplex (SBFD), also known as flexible duplex.

Further, the air interface in the RAN 200 may utilize one or more multiplexing and multiple access algorithms to enable simultaneous communication of the various devices. For example, 5G NR specifications provide multiple access for UL transmissions from UEs 222 and 224 to base station 210, and for multiplexing for DL transmissions from base station 210 to one or more UEs 222 and 224, utilizing orthogonal frequency division multiplexing (OFDM) with a cyclic prefix (CP). In addition, for UL transmissions, 5G NR specifications provide support for discrete Fourier transform-spread-OFDM (DFT-s-OFDM) with a CP (also referred to as single-carrier FDMA (SC-FDMA)). However, within the scope of the present disclosure, multiplexing and multiple access are not limited to the above schemes, and may be provided utilizing time division multiple access (TDMA), code division multiple access (CDMA), frequency division multiple access (FDMA), sparse code multiple access (SCMA), resource spread multiple access (RSMA), or other suitable multiple access schemes. Further, multiplexing DL transmissions from the base station 210 to UEs 222 and 224 may be provided utilizing time division multiplexing (TDM), code division multiplexing (CDM), frequency division multiplexing (FDM), orthogonal frequency division multiplexing (OFDM), sparse code multiplexing (SCM), or other suitable multiplexing schemes.

Deployment of communication systems, such as 5G NR systems, may be arranged in multiple manners with various components or constituent parts. In a 5G NR system or network, a network node, a network entity, a mobility element of a network, a RAN node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (eNB), NR BS, 5G NB, gNB, access point (AP), a transmit receive point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU, and RU also can be implemented as virtual units, i.e., a virtual central unit (VCU), a virtual distributed unit (VDU), or a virtual radio unit (VRU).

Base station-type operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

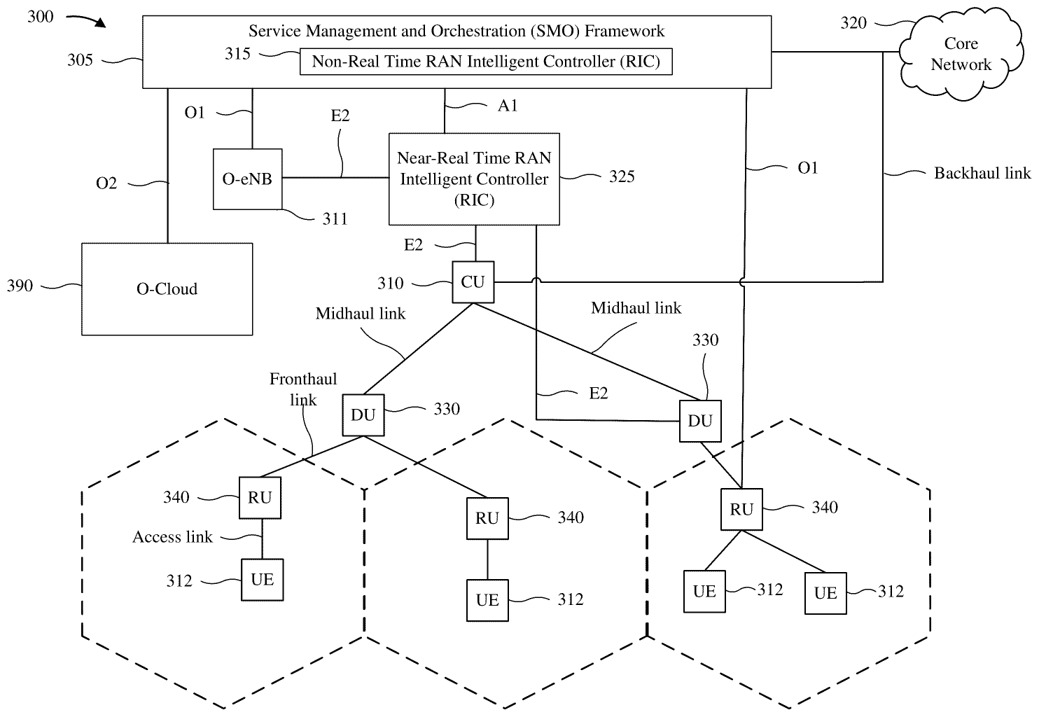

FIG. 3 shows a diagram illustrating an example of disaggregated base station 300 architecture. The disaggregated base station 300 architecture may include one or more CUs 310 that can communicate directly with a core network 320 via a backhaul link, or indirectly with the core network 320 through one or more disaggregated base station units (such as a Near-Real Time (Near-RT) RAN Intelligent Controller (RIC) 325 via an E2 link, or a Non-Real Time (Non-RT) RIC 315 associated with a Service Management and Orchestration (SMO) Framework 305, or both). A CU 310 may communicate with one or more distributed units DUs 330 via respective midhaul links, such as an F1 interface. The DUs 330 may communicate with one or more RUs 340 via respective fronthaul links. The RUs 340 may communicate with respective UEs 312 via one or more radio frequency (RF) access links. In some implementations, the UE 312 may be simultaneously served by multiple RUs 340.

Each of the units, i.e., the CUs 310, the DUs 330, the RUs 340, as well as the Near-RT RICs 325, the Non-RT RICs 315 and the SMO Framework 305, may include one or more interfaces or be coupled to one or more interfaces configured to receive or transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or transmit signals over a wired transmission medium to one or more of the other units. Additionally, the units can include a wireless interface, which may include a receiver, a transmitter, or a transceiver (such as an RF transceiver), configured to receive or transmit signals, or both, over a wireless transmission medium to one or more of the other units.

In some aspects, the CU 310 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 310. The CU 310 may be configured to handle user plane functionality (i.e., Central Unit-User Plane (CU-UP)), control plane functionality (i.e., Central Unit-Control Plane (CU-CP)), or a combination thereof. In some implementations, the CU 310 can be logically split into one or more CU-UP units and one or more CU-CP units. The CU-UP unit can communicate bidirectionally with the CU-CP unit via an interface, such as the E1 interface when implemented in an O-RAN configuration. The CU 310 can be implemented to communicate with the DU 330, as necessary, for network control and signaling.

The DU 330 may correspond to a logical unit that includes one or more base station functions to control the operation of one or more RUs 340. In some aspects, the DU 330 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3GPP. In some aspects, the DU 330 may further host one or more low PHY layers. Each layer (or module) can be implemented with an interface configured to communicate signals with other layers (and modules) hosted by the DU 330, or with the control functions hosted by the CU 310.

Lower-layer functionality can be implemented by one or more RUs 340. In some deployments, an RU 340, controlled by a DU 330, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 340 can be implemented to handle over the air (OTA) communication with one or more UEs 312. In some implementations, real-time and non-real-time aspects of control and user plane communication with the RU(s) 340 can be controlled by the corresponding DU 330. In some scenarios, this configuration can enable the DU(s) 330 and the CU 310 to be implemented in a cloud-based RAN architecture, such as a vRAN architecture.

The SMO Framework 305 may be configured to support RAN deployment and provisioning of non-virtualized and virtualized network elements. For non-virtualized network elements, the SMO Framework 305 may be configured to support the deployment of dedicated physical resources for RAN coverage requirements which may be managed via an operations and maintenance interface (such as an O1 interface). For virtualized network elements, the SMO Framework 305 may be configured to interact with a cloud computing platform (such as an open cloud (O-Cloud) 390) to perform network element life cycle management (such as to instantiate virtualized network elements) via a cloud computing platform interface (such as an O2 interface). Such virtualized network elements can include, but are not limited to, CUs 310, DUs 330, RUs 340 and Near-RT RICs 325. In some implementations, the SMO Framework 305 can communicate with a hardware aspect of a 4G RAN, such as an open eNB (O-eNB) 311, via an O1 interface. Additionally, in some implementations, the SMO Framework 305 can communicate directly with one or more RUs 340 via an O1 interface. The SMO Framework 305 also may include a Non-RT RIC 315 configured to support functionality of the SMO Framework 305.

The Non-RT RIC 315 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 325. The Non-RT RIC 315 may be coupled to or communicate with (such as via an A1 interface) the Near-RT RIC 325. The Near-RT RIC 325 may be configured to include a logical function that enables near-real-time control and optimization of RAN elements and resources via data collection and actions over an interface (such as via an E2 interface) connecting one or more CUs 310, one or more DUs 330, or both, as well as an O-eNB, with the Near-RT RIC 325.

In some implementations, to generate AI/ML models to be deployed in the Near-RT RIC 325, the Non-RT RIC 315 may receive parameters or external enrichment information from external servers. Such information may be utilized by the Near-RT RIC 325 and may be received at the SMO Framework 305 or the Non-RT RIC 315 from non-network data sources or from network functions. In some examples, the Non-RT RIC 315 or the Near-RT RIC 325 may be configured to tune RAN behavior or performance. For example, the Non-RT RIC 315 may monitor long-term trends and patterns for performance and employ AI/ML models to perform corrective actions through the SMO Framework 305 (such as reconfiguration via O1) or via the creation of RAN management policies (such as A1 policies).

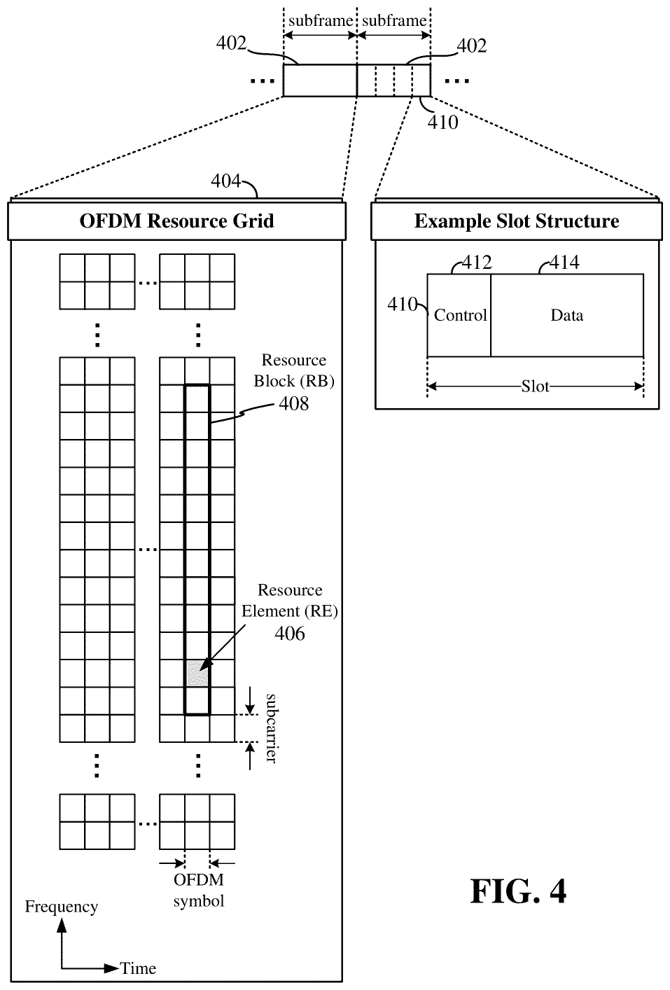

Various aspects of the present disclosure will be described with reference to an OFDM waveform, schematically illustrated in FIG. 4. It should be understood by those of ordinary skill in the art that the various aspects of the present disclosure may be applied to an SC-FDMA waveform in substantially the same way as described herein below. That is, while some examples of the present disclosure may focus on an OFDM link for clarity, it should be understood that the same principles may be applied as well to SC-FDMA waveforms.

Referring now to FIG. 4, an expanded view of an exemplary subframe 402 is illustrated, showing an OFDM resource grid. However, as those skilled in the art will readily appreciate, the PHY transmission structure for any particular application may vary from the example described here, depending on any number of factors. Here, time is in the horizontal direction with units of OFDM symbols; and frequency is in the vertical direction with units of subcarriers of the carrier.

The resource grid 404 may be used to schematically represent time-frequency resources for a given antenna port. That is, in a multiple-input-multiple-output (MIMO) implementation with multiple antenna ports available, a corresponding multiple number of resource grids 404 may be available for communication. The resource grid 404 is divided into multiple resource elements (REs) 406. An RE, which is 1 subcarrier×1 symbol, is the smallest discrete part of the time-frequency grid, and contains a single complex value representing data from a physical channel or signal. Depending on the modulation utilized in a particular implementation, each RE may represent one or more bits of information. In some examples, a block of REs may be referred to as a physical resource block (PRB) or more simply a resource block (RB) 408, which contains any suitable number of consecutive subcarriers in the frequency domain. In one example, an RB may include 12 subcarriers, a number independent of the numerology used. In some examples, depending on the numerology, an RB may include any suitable number of consecutive OFDM symbols in the time domain. Within the present disclosure, it is assumed that a single RB such as the RB 408 entirely corresponds to a single direction of communication (either transmission or reception for a given device).

A set of continuous or discontinuous resource blocks may be referred to herein as a Resource Block Group (RBG), sub-band, or bandwidth part (BWP). A set of sub-bands or BWPs may span the entire bandwidth. Scheduling of scheduled entities (e.g., UEs) for downlink, uplink, or sidelink transmissions typically involves scheduling one or more resource elements 406 within one or more sub-bands or bandwidth parts (BWPs). Thus, a UE generally utilizes only a subset of the resource grid 404. In some examples, an RB may be the smallest unit of resources that can be allocated to a UE. Thus, the more RBs scheduled for a UE, and the higher the modulation scheme chosen for the air interface, the higher the data rate for the UE. The RBs may be scheduled by a scheduling entity, such as a base station (e.g., gNB, eNB, etc.), or may be self-scheduled by a UE implementing D2D sidelink communication.

In this illustration, the RB 408 is shown as occupying less than the entire bandwidth of the subframe 402, with some subcarriers illustrated above and below the RB 408. In a given implementation, the subframe 402 may have a bandwidth corresponding to any number of one or more RBs 408. Further, in this illustration, the RB 408 is shown as occupying less than the entire duration of the subframe 402, although this is merely one possible example.

Each 1 ms subframe 402 may consist of one or multiple adjacent slots. In the example shown in FIG. 4, one subframe 402 includes four slots 410, as an illustrative example. In some examples, a slot may be defined according to a specified number of OFDM symbols with a given cyclic prefix (CP) length. For example, a slot may include 7 or 14 OFDM symbols with a nominal CP. Additional examples may include mini-slots, sometimes referred to as shortened transmission time intervals (TTIs), having a shorter duration (e.g., one to three OFDM symbols). These mini-slots or shortened transmission time intervals (TTIs) may in some cases be transmitted occupying resources scheduled for ongoing slot transmissions for the same or for different UEs. Any number of resource blocks may be utilized within a subframe or slot.

An expanded view of one of the slots 410 illustrates the slot 410 including a control region 412 and a data region 414. In general, the control region 412 may carry control channels, and the data region 414 may carry data channels. Of course, a slot may contain all DL, all UL, or at least one DL portion and at least one UL portion. The structure illustrated in FIG. 4 is merely exemplary in nature, and different slot structures may be utilized, and may include one or more of each of the control region(s) and data region(s).

Although not illustrated in FIG. 4, the various REs 406 within an RB 408 may be scheduled to carry one or more physical channels, including control channels, shared channels, data channels, etc. Other REs 406 within the RB 408 may also carry pilots or reference signals. These pilots or reference signals may provide for a receiving device to perform channel estimation of the corresponding channel, which may enable coherent demodulation/detection of the control and/or data channels within the RB 408.

In some examples, the slot 410 may be utilized for broadcast, multicast, groupcast, or unicast communication. For example, a broadcast, multicast, or groupcast communication may refer to a point-to-multipoint transmission by one device (e.g., a base station, UE, or other similar device) to other devices. Here, a broadcast communication is delivered to all devices, whereas a multicast or groupcast communication is delivered to multiple intended recipient devices. A unicast communication may refer to a point-to-point transmission by a one device to a single other device.

In an example of cellular communication over a cellular carrier via a Uu interface, for a DL transmission, the scheduling entity (e.g., a base station) may allocate one or more REs 406 (e.g., within the control region 412) to carry DL control information including one or more DL control channels, such as a physical downlink control channel (PDCCH), to one or more scheduled entities (e.g., UEs). The PDCCH carries downlink control information (DCI) including but not limited to power control commands (e.g., one or more open loop power control parameters and/or one or more closed loop power control parameters), scheduling information, a grant, and/or an assignment of REs for DL and UL transmissions. The PDCCH may further carry hybrid automatic repeat request (HARQ) feedback transmissions such as an acknowledgment (ACK) or negative acknowledgment (NACK). HARQ is a technique well-known to those of ordinary skill in the art, wherein the integrity of packet transmissions may be checked at the receiving side for accuracy, e.g., utilizing any suitable integrity checking mechanism, such as a checksum or a cyclic redundancy check (CRC). If the integrity of the transmission is confirmed, an ACK may be transmitted, whereas if not confirmed, a NACK may be transmitted. In response to a NACK, the transmitting device may send a HARQ retransmission, which may implement chase combining, incremental redundancy, etc.

The base station may further allocate one or more REs 406 (e.g., in the control region 412 or the data region 414) to carry other DL signals, such as a demodulation reference signal (DMRS); a phase-tracking reference signal (PT-RS); a channel state information (CSI) reference signal (CSI-RS); and a synchronization signal block (SSB). SSBs may be broadcast at regular intervals based on a periodicity (e.g., 5, 10, 20, 40, 80, or 160 ms). An SSB includes a primary synchronization signal (PSS), a secondary synchronization signal (SSS), and a physical broadcast control channel (PBCH). A UE may utilize the PSS and SSS to achieve radio frame, subframe, slot, and symbol synchronization in the time domain, identify the center of the channel (system) bandwidth in the frequency domain, and identify the physical cell identity (PCI) of the cell.

The PBCH in the SSB may further include a master information block (MIB) that includes various system information, along with parameters for decoding a system information block (SIB). The SIB may be, for example, a SystemInformationType 1 (SIB1) that may include various additional system information. The MIB and SIB1 together provide the minimum system information (SI) for initial access. Examples of system information transmitted in the MIB may include, but are not limited to, a subcarrier spacing (e.g., default downlink numerology), system frame number, a configuration of a PDCCH control resource set (CORESET) (e.g., PDCCH CORESET0), a cell barred indicator, a cell reselection indicator, a raster offset, and a search space for SIB1. Examples of remaining minimum system information (RMSI) transmitted in the SIB1 may include, but are not limited to, a random access search space, a paging search space, downlink configuration information, and uplink configuration information. A base station may transmit other system information (OSI) as well.

In an UL transmission, the scheduled entity (e.g., UE) may utilize one or more REs 406 to carry UL control information (UCI) including one or more UL control channels, such as a physical uplink control channel (PUCCH), to the scheduling entity. UCI may include a variety of packet types and categories, including pilots, reference signals, and information configured to enable or assist in decoding uplink data transmissions. Examples of uplink reference signals may include a sounding reference signal (SRS) and an uplink DMRS. In some examples, the UCI may include a scheduling request (SR), i.e., request for the scheduling entity to schedule uplink transmissions. Here, in response to the SR transmitted on the UCI, the scheduling entity may transmit downlink control information (DCI) that may schedule resources for uplink packet transmissions. UCI may also include HARQ feedback, channel state feedback (CSF), such as a CSI report, or any other suitable UCI.

In addition to control information, one or more REs 406 (e.g., within the data region 414) may be allocated for data traffic. Such data traffic may be carried on one or more traffic channels, such as, for a DL transmission, a physical downlink shared channel (PDSCH); or for an UL transmission, a physical uplink shared channel (PUSCH). In some examples, one or more REs 406 within the data region 414 may be configured to carry other signals, such as one or more SIBs and DMRSs. In some examples, the PDSCH may carry a plurality of SIBs, not limited to SIB1, discussed above. For example, the OSI may be provided in these SIBs, e.g., SIB2 and above.

In an example of sidelink communication over a sidelink carrier via a proximity service (ProSe) PC5 interface, the control region 412 of the slot 410 may include a physical sidelink control channel (PSCCH) including sidelink control information (SCI) transmitted by an initiating (transmitting) sidelink device (e.g., Tx V2X device or other Tx UE) towards a set of one or more other receiving sidelink devices (e.g., Rx V2X device or other Rx UE). The data region 414 of the slot 410 may include a physical sidelink shared channel (PSSCH) including sidelink data traffic transmitted by the initiating (transmitting) sidelink device within resources reserved over the sidelink carrier by the transmitting sidelink device via the SCI. Other information may further be transmitted over various REs 406 within slot 410. For example, HARQ feedback information may be transmitted in a physical sidelink feedback channel (PSFCH) within the slot 410 from the receiving sidelink device to the transmitting sidelink device. In addition, one or more reference signals, such as a sidelink SSB, a sidelink CSI-RS, a sidelink SRS, and/or a sidelink positioning reference signal (PRS) may be transmitted within the slot 410.

These physical channels described above are generally multiplexed and mapped to transport channels for handling at the medium access control (MAC) layer. Transport channels carry blocks of information called transport blocks (TB). The transport block size (TBS), which may correspond to a number of bits of information, may be a controlled parameter, based on the modulation and coding scheme (MCS) and the number of RBs in a given transmission.

The channels or carriers illustrated in FIG. 4 are not necessarily all of the channels or carriers that may be utilized between devices, and those of ordinary skill in the art will recognize that other channels or carriers may be utilized in addition to those illustrated, such as other traffic, control, and feedback channels.

These physical channels described above are generally multiplexed and mapped to transport channels for handling at the medium access control (MAC) layer. Transport channels carry blocks of information called transport blocks (TB). The transport block size (TBS), which may correspond to a number of bits of information, may be a controlled parameter, based on the modulation and coding scheme (MCS) and the number of RBs in a given transmission.

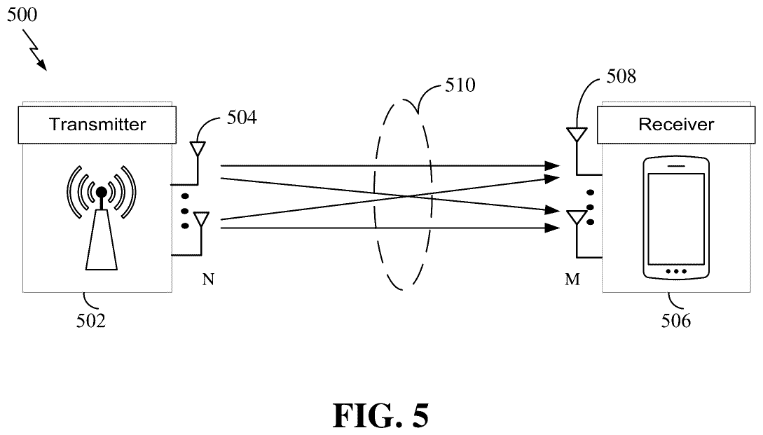

In some aspects of the disclosure, the network entity (e.g., base station) and/or scheduled entity (e.g., UE) may be configured for beamforming and/or multiple-input multiple-output (MIMO) technology. FIG. 5 illustrates an example of a wireless communication system 500 supporting MIMO. In a MIMO system, a transmitter 502 includes multiple transmit antennas 504 (e.g., N transmit antennas) and a receiver 506 includes multiple receive antennas 508 (e.g., M receive antennas). Thus, there are N×M signal paths 510 from the transmit antennas 504 to the receive antennas 508. Each of the transmitter 502 and the receiver 506 may be implemented, for example, within a scheduling entity 108, a scheduled entity 106, or any other suitable wireless communication device.

The use of such multiple antenna technology enables the wireless communication system to exploit the spatial domain to support spatial multiplexing, beamforming, and transmit diversity. Spatial multiplexing may be used to transmit different streams of data, also referred to as layers, simultaneously on the same time-frequency resource. The data streams may be transmitted to a single UE to increase the data rate or to multiple UEs to increase the overall system capacity, the latter being referred to as multi-user MIMO (MU-MIMO). This is achieved by spatially precoding each data stream (i.e., multiplying the data streams with different weighting and phase shifting) and then transmitting each spatially precoded stream through multiple transmit antennas on the downlink. The spatially precoded data streams arrive at the UE(s) with different spatial signatures, which enables each of the UE(s) to recover the one or more data streams destined for that UE. On the uplink, each UE transmits a spatially precoded data stream, which enables the base station to identify the source of each spatially precoded data stream.

The number of data streams or layers corresponds to the rank of the transmission. In general, the rank of the MIMO system 500 is limited by the number of transmit or receive antennas 504 or 508, whichever is lower. In addition, the channel conditions at the UE, as well as other considerations, such as the available resources at the base station, may also affect the transmission rank. For example, the rank (and therefore, the number of data streams) assigned to a particular UE on the downlink may be determined based on the rank indicator (RI) transmitted from the UE to the base station. The RI may be determined based on the antenna configuration (e.g., the number of transmit and receive antennas) and a measured signal-to-interference-and-noise ratio (SINR) on each of the receive antennas. The RI may indicate, for example, the number of layers that may be supported under the current channel conditions. The base station may use the RI, along with resource information (e.g., the available resources and amount of data to be scheduled for the UE), to assign a transmission rank to the UE.

In Time Division Duplex (TDD) systems, the UL and DL are reciprocal, in that each uses different time slots of the same frequency bandwidth. Therefore, in TDD systems, the base station may assign the rank for DL MIMO transmissions based on UL SINR measurements (e.g., based on a Sounding Reference Signal (SRS) transmitted from the UE or other pilot signal). Based on the assigned rank, the base station may then transmit CSI-RSs with separate C-RS sequences for each layer to provide for multi-layer channel estimation. From the CSI-RS, the UE may measure the channel quality across layers and resource blocks and feed back the RI and a channel quality indicator (CQI) that indicates to the base station a modulation and coding scheme (MCS) to use for transmissions to the UE for use in updating the rank and assigning REs for future downlink transmissions.

In the simplest case, as shown in FIG. 5, a rank-2 spatial multiplexing transmission on a 2×2 MIMO antenna configuration will transmit one data stream from each transmit antenna 504. Each data stream reaches each receive antenna 508 along a different signal path 510. The receiver 506 may then reconstruct the data streams using the received signals from each receive antenna 508.

The electromagnetic spectrum is often subdivided, based on frequency/wavelength, into various classes, bands, channels, etc. In 5G NR two initial operating bands have been identified as frequency range designations FR1 (410 MHz-7.125 GHz) and FR2 (24.25 GHz-52.6 GHz). It should be understood that although a portion of FR1 is greater than 6 GHz, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4-a or FR4-1 (52.6 GHz-71 GHz), FR4 (52.6 GHz-114.25 GHz), and FR5 (114.25 GHz-300 GHz). Each of these higher frequency bands falls within the EHF band.

With the above aspects in mind, unless specifically stated otherwise, it should be understood that the term “sub-6 GHz” or the like if used herein may broadly represent frequencies that may be less than 6 GHz, may be within FR1, or may include mid-band frequencies. Further, unless specifically stated otherwise, it should be understood that the term “millimeter wave” or the like if used herein may broadly represent frequencies that may include mid-band frequencies, may be within FR2, FR4, FR4-a or FR4-1, and/or FR5, or may be within the EHF band.

Beamforming is a signal processing technique that may be used at the transmitter 502 or receiver 506 to shape or steer an antenna beam (e.g., a transmit beam or receive beam) along a spatial path between the transmitter 502 and the receiver 506. Beamforming may be achieved by combining the signals communicated via antennas 504 or 508 (e.g., antenna elements of an antenna array module) such that some of the signals experience constructive interference while others experience destructive interference. To create the desired constructive/destructive interference, the transmitter 502 or receiver 506 may apply amplitude and/or phase offsets to signals transmitted or received from each of the antennas 504 or 508 associated with the transmitter 502 or receiver 506.

In 5G NR systems, particularly for FR2 (millimeter wave) systems, beamformed signals may be utilized for most downlink channels, including the PDCCH and PDSCH. In addition, broadcast control information, such as the SSB, slot format indicator (SFI), and paging information, may be transmitted in a beam-sweeping manner to enable all scheduled entities (UEs) in the coverage area of a transmission and reception point (TRP) (e.g., a gNB, base station) to receive the broadcast control information. In addition, for UEs configured with beamforming antenna arrays, beamformed signals may also be utilized for uplink channels, including the PUCCH and PUSCH. In addition, beamformed signals may further be utilized in D2D systems, such as NR sidelink (SL) or V2X, utilizing FR2.

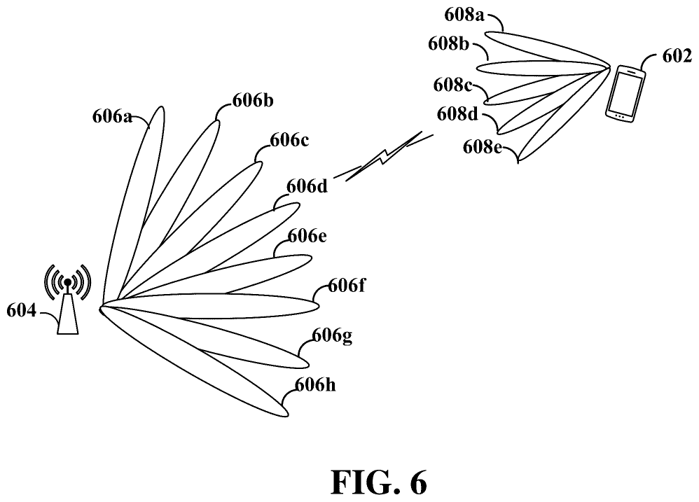

FIG. 6 is a diagram illustrating communication between a network entity (e.g., base station 604) and a UE 602 using beamformed signals according to some aspects. The base station 604 may be any of the base stations (e.g., gNBs), scheduling entities, or network entities illustrated in FIGS. 1, 2, and/or 3, and the UE 602 may be any of the UEs or scheduled entities illustrated in FIGS. 1, 2, and/or 3.

The base station 604 may generally be capable of communicating with the UE 602 using one or more transmit beams, and the UE 602 may further be capable of communicating with the base station 604 using one or more receive beams. As used herein, the term transmit beam refers to a beam on the base station 604 that may be utilized for downlink or uplink communication with the UE 602. In addition, the term receive beam refers to a beam on the UE 602 that may be utilized for downlink or uplink communication with the base station 604.

In the example shown in FIG. 6, the base station 604 is configured to generate a plurality of transmit beams 606a-606h, each associated with a different spatial direction. In addition, the UE 602 is configured to generate a plurality of receive beams 608a-608e, each associated with a different spatial direction. It should be noted that while some beams are illustrated as adjacent to one another, such an arrangement may be different in different aspects. For example, transmit beams 606a-606h transmitted during a same symbol may not be adjacent to one another. In some examples, the base station 604 and UE 602 may each transmit more or less beams distributed in all directions (e.g., 360 degrees) and in three dimensions. In addition, the transmit beams 606a-606h may include beams of varying beam width. For example, the base station 604 may transmit certain signals (e.g., SSBs) on wider beams and other signals (e.g., CSI-RSs) on narrower beams.

The base station 604 and UE 602 may select one or more transmit beams 606a-606h on the base station 604 and one or more receive beams 608a-608e on the UE 602 for communication of uplink and downlink signals therebetween using a beam management procedure. In one example, during initial cell acquisition, the UE 602 may perform a P1 beam management procedure to scan the plurality of transmit beams 606a-606h on the plurality of receive beams 608a-608e to select a beam pair link (e.g., one of the transmit beams 606a-606h and one of the receive beams 608a-608e) for a physical random access channel (PRACH) procedure for initial access to the cell. For example, periodic SSB beam sweeping may be implemented on the base station 604 at certain intervals (e.g., based on the SSB periodicity). Thus, the base station 604 may be configured to sweep or transmit an SSB on each of a plurality of wider transmit beams 606a-606h during the beam sweeping interval. The UE may measure the reference signal received power (RSRP) of each of the SSB transmit beams on each of the receive beams of the UE and select the transmit and receive beams based on the measured RSRP. In an example, the selected receive beam may be the receive beam on which the highest RSRP is measured and the selected transmit beam may have the highest RSRP as measured on the selected receive beam.

After completing the PRACH procedure, the base station 604 and UE 602 may perform a P2 beam management procedure for beam refinement at the base station 604. For example, the base station 604 may be configured to sweep or transmit a CSI-RS on each of a plurality of narrower transmit beams 606a-606h. Each of the narrower CSI-RS beams may be a sub-beam of the selected SSB transmit beam (e.g., within the spatial direction of the SSB transmit beam). Transmission of the CSI-RS transmit beams may occur periodically (e.g., as configured via radio resource control (RRC) signaling by the gNB), semi-persistently (e.g., as configured via RRC signaling and activated/deactivated via medium access control-control element (MAC-CE) signaling by the gNB), or aperiodically (e.g., as triggered by the gNB via downlink control information (DCI)). The UE 602 is configured to scan the plurality of CSI-RS transmit beams 606a-606h on the plurality of receive beams 608a-608e. The UE 602 then performs beam measurements (e.g., RSRP, SINR, etc.) of the received CSI-RSs on each of the receive beams 608a-608e to determine the respective beam quality of each of the CSI-RS transmit beams 606a-606h as measured on each of the receive beams 608a-608e.

The UE 602 can then generate and transmit a Layer 1 (L1) measurement report, including the respective beam index (e.g., CSI-RS resource indicator (CRI)) and beam measurement (e.g., RSRP or SINR) of one or more of the CSI-RS transmit beams 606a-606h on one or more of the receive beams 608a-608e to the base station 604. The base station 604 may then select one or more CSI-RS transmit beams on which to communicate downlink and/or uplink control and/or data with the UE 602. In some examples, the selected CSI-RS transmit beam(s) have the highest RSRP from the L1 measurement report. Transmission of the L1 measurement report may occur periodically (e.g., as configured via RRC signaling by the gNB), semi-persistently (e.g., as configured via RRC signaling and activated/deactivated via MAC-CE signaling by the gNB), or aperiodically (e.g., as triggered by the gNB via DCI).

The UE 602 may further select a corresponding receive beam on the UE 602 for each selected serving CSI-RS transmit beam to form a respective beam pair link (BPL) for each selected serving CSI-RS transmit beam. For example, the UE 602 can utilize the beam measurements obtained during the P2 procedure or perform a P3 beam management procedure to obtain new beam measurements for the selected CSI-RS transmit beams to select the corresponding receive beam for each selected transmit beam. In some examples, the selected receive beam to pair with a particular CSI-RS transmit beam may be the receive beam on which the highest RSRP for the particular CSI-RS transmit beam is measured.

In some examples, in addition to performing CSI-RS beam measurements, the base station 604 may configure the UE 602 to perform SSB beam measurements and provide an L1 measurement report containing beam measurements of SSB transmit beams 606a-606h. For example, the base station 604 may configure the UE 602 to perform SSB beam measurements and/or CSI-RS beam measurements for beam failure detection (BRD), beam failure recovery (BFR), cell reselection, beam tracking (e.g., for a mobile UE 602 and/or base station 604), or other beam optimization purpose.

In addition, when the channel is reciprocal, the transmit and receive beams may be selected using an uplink beam management scheme. In an example, the UE 602 may be configured to sweep or transmit on each of a plurality of receive beams 608a-608e. For example, the UE 602 may transmit an SRS on each beam in the different beam directions. In addition, the base station 604 may be configured to receive the uplink beam reference signals on a plurality of transmit beams 606a-606h. The base station 604 then performs beam measurements (e.g., RSRP, SINR, etc.) of the beam reference signals on each of the transmit beams 606a-606h to determine the respective beam quality of each of the receive beams 608a-608e as measured on each of the transmit beams 606a-606h.

The base station 604 may then select one or more transmit beams on which to communicate downlink and/or uplink control and/or data with the UE 602. In some examples, the selected transmit beam(s) have the highest RSRP. The UE 602 may then select a corresponding receive beam for each selected serving transmit beam to form a respective beam pair link (BPL) for each selected serving transmit beam, using, for example, a P3 beam management procedure, as described above.

In one example, a single CSI-RS transmit beam (e.g., beam 606d) on the base station 604 and a single receive beam (e.g., beam 608c) on the UE may form a single BPL used for communication between the base station 604 and the UE 602. In another example, multiple CSI-RS transmit beams (e.g., beams 606c, 606d, and 606e) on the base station 604 and a single receive beam (e.g., beam 608c) on the UE 602 may form respective BPLs used for communication between the base station 604 and the UE 602. In another example, multiple CSI-RS transmit beams (e.g., beams 606c, 606d, and 606e) on the base station 604 and multiple receive beams (e.g., beams 608c and 608d) on the UE 602 may form multiple BPLs used for communication between the base station 604 and the UE 602. In this example, a first BPL may include transmit beam 606c and receive beam 608c, a second BPL may include transmit beam 608d and receive beam 608c, and a third BPL may include transmit beam 608e and receive beam 608d.

In addition to L1 measurement reports, the UE 602 can further utilize the beam reference signals to estimate the channel quality of the channel between the network entity 604 and the UE 602. For example, the UE 602 may measure the SINR of each received CSI-RS and generate a CSI report based on the measured SINR. The CSI report may include, for example, a channel quality indicator (CQI), rank indicator (RI), precoding matrix indicator (PMI), and/or layer indicator (LI). The network entity (e.g., gNB) may use the CSI report to select a rank for the UE, along with a precoding matrix and a MCS to use for future downlink transmissions to the UE. The MCS may be selected from one or more MCS tables, each associated with a particular type of coding (e.g., polar coding, LDPC, etc.) or modulation (e.g., binary phase shift keying (BPSK), quadrature phase shift keying (QPSK), 16 quadrature amplitude modulation (QAM), 64 QAM, 256 QAM, etc.). The LI may be utilized to indicate which column of the precoding matrix of the reported PMI corresponds to the strongest layer codeword corresponding to the largest reported wideband CQI.

To distinguish between the different types of reports (including CSI reports and L1 measurement reports) and different types of measurements, the network entity 604 may configure the UE 602 with one or more report settings. Each report setting may be associated with a reference signal configuration indicating a configuration of one or more reference signals (e.g., CSI-RSs) for use in generating the CSI report. In some examples, a report setting may be associated with a combined reference signal configuration.

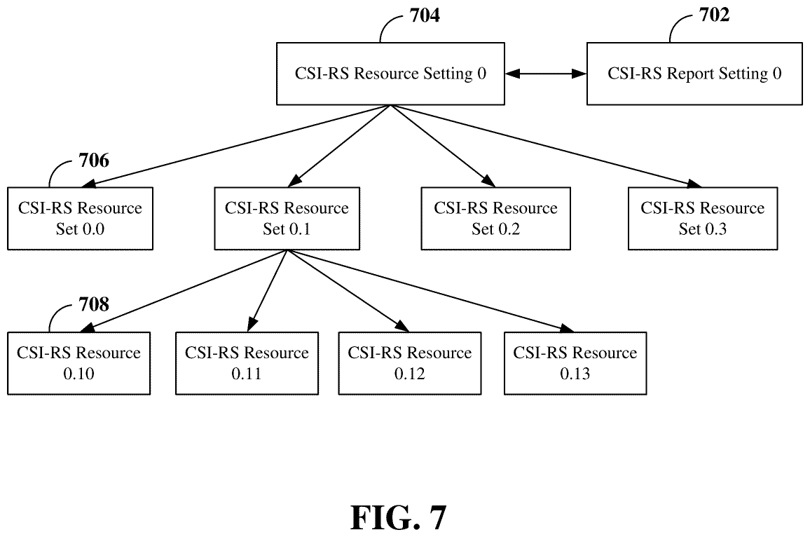

FIG. 7 illustrates an exemplary CSI resource mapping to support different report/measurement configurations. The CSI resource mapping includes CSI report setting 702, CSI resource settings 704, CSI resource sets 706, and CSI resources 708. Each CSI resource setting 704 includes one or more CSI resource sets 706, and each CSI resource set 706 includes one or more CSI resources 708. In the example shown in FIG. 7, a single CSI resource setting (e.g., CSI resource setting 0) is illustrated. However, it should be understood that any suitable number of CSI resource settings 704 may be supported.

Each CSI report setting 702 may include a reportQuantity that indicates, for example, the specific CSI parameters and granularity thereof (e.g., wideband/sub-band CQI, PMI, RI, etc.), or L1 parameters (e.g., L1-RSRP, L1-SINR) to include in a CSI report. The CSI report setting 702 may further indicate a periodicity of the CSI report. For example, the CSI report setting 702 may indicate that the report should be generated periodically, aperiodically, or semi-persistently. For aperiodic CSI report settings, the CSI report may be sent on the PUSCH. For periodic CSI report settings, the CSI report may be sent on the PUCCH. For semi-persistent CSI report settings, the CSI report may be sent on the PUCCH or the PUSCH. For example, semi-persistent CSI reports sent on the PUCCH may be activated or deactivated using a medium access control (MAC) control element (MAC-CE). Semi-persistent CSI reports sent on the PUSCH may be triggered using downlink control information (DCI) scrambled with a semi-persistent CSI (SP-CP) radio network temporary identifier (SP-CP-RNTI). CSI report settings 702 may further include a respective priority and other suitable parameters.

Each CSI report setting 702 may be linked to a CSI resource setting 704. Each CSI resource setting 704 may be associated with a particular time domain behavior of reference signals. For example, each CSI resource setting 704 may include periodic, semi-persistent, or aperiodic CSI resources 708. For periodic and semi-persistent CSI resource settings 704, the number of configured CSI resource sets 706 may be limited to one. In general, the CSI resource settings 704 that may be linked to a particular CSI report setting 702 may be limited by the time domain behavior of the CSI resource setting 704 and the CSI report setting 702. For example, an aperiodic CSI report setting 702 may be linked to periodic, semi-persistent, or aperiodic CSI resource settings 704. However, a semi-persistent CSI report setting 702 may be linked to only periodic or semi-persistent CSI resource settings 704. In addition, a periodic CSI report setting 702 may be linked to only a periodic CSI resource setting 704.

Each CSI resource set 706 may be associated with a CSI resource type. For example, CSI resource types may include non-zero-power (NZP) CSI-RS resources, SSB resources, or channel state information interference measurement (CSI-IM) resources. Thus, the CSI resources 708 may include channel measurement resources (CMRs), such as NZP CSI-RS or SSB resources, and/or interference measurement resources (IMRs), such as CSI-IM resources. Each CSI resource set 706 includes a list of CSI resources 708 of a particular CSI resource type. In addition, each CSI resource set 706 may further be associated with one or more of a set of frequency resources (e.g., a bandwidth and/or OFDM symbol(s) within a slot), a particular set of ports, a power, or other suitable parameters.

Each CSI resource 708 indicates the particular beam (e.g., ports), frequency resource, and OFDM symbol on which the reference signal may be measured by the wireless communication device. For example, each CSI-RS resource 708 may indicate an RE on which a CSI-RS pilot or SSB transmitted from a particular set of ports (e.g., on a particular beam) may be measured. In the example shown in FIG. 7, CSI-RS resource set 0.1 includes four CSI-RS resources (CSI-RS resource 0.10, CSI-RS resource 0.11, CSI-RS resource 0.12, and CSI-RS resource 0.13). Each CSI resource 708 may further be indexed by a respective beam identifier (ID). The beam ID may identify not only the particular beam (e.g., ports), but also the resources on which the reference signal may be measured. For example, the beam ID may include a CSI-RS resource indicator (CRI) or an SSB resource indicator (SSBRI).

A scheduling entity (e.g., a network entity, gNB) may configure a scheduled entity (e.g., UE) with one or more CSI report settings 702 and CSI resource settings 704 via, for example, radio resource control (RRC) signaling. For example, the scheduling entity may configure the scheduled entity with a list of periodic CSI report settings 702 indicating the associated CSI resource set 706 that the scheduled entity may utilize to generate periodic CSI reports. As another example, the scheduling entity may configure the scheduled entity with a list of aperiodic CSI report settings in a CSI-AperiodicTriggerStateList. Each trigger state in the CSI-AperiodicTriggerStateList may include a list of aperiodic CSI report settings 702 indicating the associated CSI resource sets 706 for channel (and optionally interference) measurement. As another example, the scheduling entity may configure the scheduled entity with a list of semi-persistent CSI report settings in a CSI-SemiPersistentOnPUSCH-TriggerStateList. Each trigger state in the CSI-SemiPersistentOnPUSCH-TriggerStateList may include one CSI report setting 702 indicating the associated CSI resource set 706. The scheduling entity may then trigger one or more of the aperiodic or semi-persistent trigger states using, for example, DCI. As indicated above, a MAC-CE may be used to activate or deactivate a semi-persistent CSI report setting 702 for a CSI report sent on the PUCCH.

For L1-RSRP measurement reports, the scheduled entity may be configured with a CSI resource setting 704 having up to sixteen CSI resource sets 706. Each of the CSI resource sets 706 may include up to sixty-four CSI resources 708 in each set. The total number of different CSI resources 708 over all the CSI resource sets 706 may be no more than 128. For L1-SINR measurement reports, the scheduled entity may be configured with a CSI resource setting 704 that can include up to 64 CSI resources 708 (e.g., up to 64 CSI-RS resource or up to 64 SSB resources).

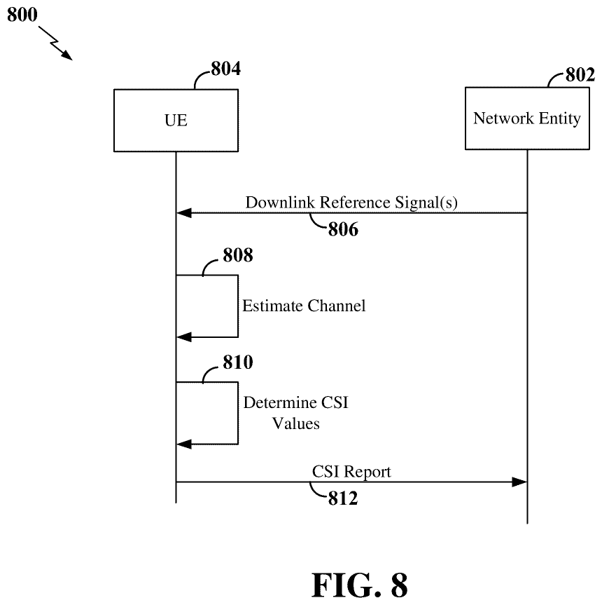

FIG. 8 is a signaling diagram illustrating exemplary signaling 800 between a network entity 802 and a UE 804 to provide channel state information feedback (CSF) within a wireless network. In the illustrated scenario, the UE 804 can provide a CSI report to the network entity 802. The network entity 802 may correspond, for example, to a base station or other network entity as shown in FIGS. 1, 2, and/or 3. The network entity 802 may be implemented as an aggregated base station or a disaggregated base station. In a disaggregated base station architecture, the network entity 802 may include one or more of a CU, a DU, or a RU. The UE 804 may correspond, for example, to a UE or other scheduled node as shown in FIGS. 1, 2, and/or 3.

At 806, the network entity 802 may transmit a reference signal, such as a DL-RS (e.g., CSI-RS, SSB), to the UE 804. In some examples, the reference signal may include a plurality of reference signals or a burst of reference signals. Reference signals may be transmitted via a respective channel measurement resource. Channel measurement resources may include time-frequency resources, along with a beam direction, within which a particular reference signal can be transmitted. For example, channel measurement resources may include a non-zero-power (NZP) CSI-RS resource. NZP resources can be utilized for channel measurement, along with one or more interference measurement resources that may be utilized for interference measurements. Interference measurement resources may include a zero-power (ZP) CSI-RS resource and an NZP CSI-RS resource with similar properties as the NZP CSI-RS resource utilized for channel measurement. In addition, each reference signal may include a number of pilots allocated within the respective channel measurement resource.

At 808, the UE 804 can estimate the wireless channel based on the reference signal(s). For example, the UE 804 may measure the SINR and/or RSRP of one or more of the reference signals to obtain a signal quality and/or channel estimate of the wireless channel.

At 810, the UE 804 may determine various CSI values from the signal quality and/or channel estimate. For example, the UE 804 may determine a RI, PMI, and/or CQI from the channel estimate. The CQI may include an index (e.g., a CQI index) ranging, for example, from 0 to 15. The CQI index may indicate, for example, the highest MCS at which the Block Error Rate (BLER) of the channel does not exceed 10%. Once determined, the CSI values can be fed back. For example, at 812, the UE 804 may transmit a CSI report, including the determined signal quality and/or CSI values to the network entity 802.

The network entity 802 and UE 804 may each support different types of CSI reports (including L1 measurement reports) and/or different types of measurements. To distinguish between the different report/measurement types and measurement configurations, the network entity 802 may configure the UE 804 with one or more report settings. Each report setting may be associated with a resource setting indicating a configuration of one or more reference signals (e.g., CSI-RS, SSB) for use in generating the CSI report.

### Beam Prediction

Aspects of the present disclosure disclose techniques and apparatuses for beam prediction and switching beam prediction modes. In some aspects, a UE can select one or more beams based on a beam prediction, instead of selecting a beam simply based on beam measurements (e.g., RSRP of a reference signal (e.g., CSI-RS or SSB) only. Beam prediction can be made in time and/or spatial domain for overhead and latency reduction. Given past beam measurements (e.g., RSRP), the future beam prediction can be affected by channel fading and noise, UE future location, error of a prediction model, etc. Therefore, predicting the beam RSRP (e.g., mean RSRP) alone may not be sufficient to make reliable beam prediction for future scheduling decision.

In some aspects, the UE can predict the mean beam RSRP of one or more beams and the associated standard deviation (SD) based on past beam measurements (e.g., RSRP). The SD of predicted RSRPs can indicate a confidence level of the mean RSRP prediction. For example, the SD information can indicate the level of prediction error, and help the UE proactively avoid using bad beam prediction. Beam prediction with confidence indication (e.g., SD) can enable more reliable beam prediction, efficient beam measurement control. For example, the confidence indication enables a UE to proactively reject bad beam prediction results to achieve more accurate beam selection/prediction. With beam prediction, the UE may reduce beam failure, achieve higher throughput, and reduce power consumption and report overhead.

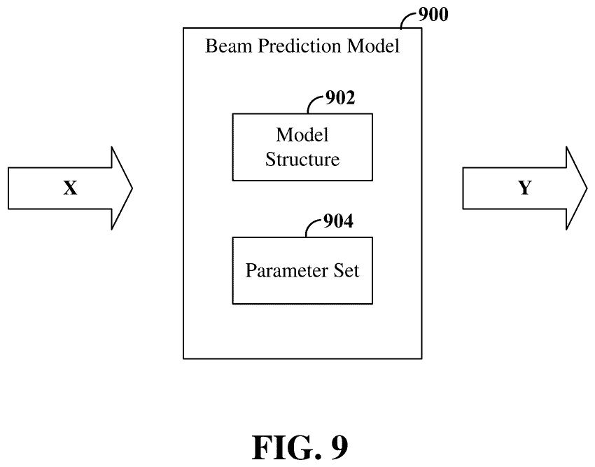

FIG. 9 is a block diagram illustrating a beam prediction model 900 for beam prediction according to some aspects. In one aspect, the beam prediction model 900 may use a machine learning model (e.g., a neural network function (NNF)) to predict one or more beams or beam metrics for communication between a network entity and a UE. In one example, the beam prediction model 900 may be predefined in a communication standard (e.g., a 3GPP 5G NR specification) or based on a UE-specific implementation. In one aspect, the beam prediction model 900 can be configured to use one or more NNFs for beam prediction, and each configured NNF can be identified by an NNF ID. The input (X) parameters and output (Y) parameters of the beam prediction model 900 can be preconfigured for each NNF. Different NNF may use different input and/or output parameters.

In some aspects, the beam prediction model 900 can be defined in terms of a model structure 902 and a parameter set 904. The model structure 902 can be identified by a unique model ID and associated with an NNF. Each model structure 902 has a default parameter set 904 that can include various parameters. For example, the parameter sets 904 may include the various parameters used by the model structure 902. For example, the parameter set 904 may include machine learning parameters that are location and/or configuration specific.

In one aspect, the input (X) of the beam prediction model 900 can be past measurements of a first set of beams (beam set 1), and the output (Y) of the beam prediction model 900 can be predicted beam metrics (e.g., RSRP) of a second set of beams (beam set 2). The beam prediction model 900 can use a trained algorithm to perform the beam prediction based on past beam measurements. For example, the algorithm may be a machine learning (ML) algorithm (e.g., recursive neural network algorithm) or a non-learning type algorithm. The algorithm can be trained and maintained by a network entity (e.g., a base station, gNB, CU, or DU). In some aspects, the beam prediction model or its associated NNF can be implemented at a network entity and/or a UE to predict one or more future beams or beam quality. If the beam prediction model is implemented at the UE, the network entity can configure the particular beam prediction model used at the UE. In some aspects, the beam prediction model 900 can be implemented at both the network entity and the UE.

In some aspects, the input and output of the beam prediction model 900 can be associated with the same, overlapped, or completely different beam sets. In one example, the UE can measure a subset of SSB beams to predict all SSB beams to use in the future. In one example, the UE can measure course beams (e.g., SSB beams) to predict more refined or narrow beams (e.g., CSI-RS beams) for unicast PDSCH/PDCCH transmissions. In some examples, the beam prediction model 900 can be configured to output one or more beam indices and/or other related beam metrics for the future time. Using beam prediction, the UE can reduce reference signal (RS) measurement overhead (e.g., no need to send RS to track beam/channel as frequently). The UE may also reduce the overhead of UL feedback because the UE can provide channel feedback or estimation less frequently. Further, the UE can reduce power consumption because the UE can measure and feedback beam/channel quality less frequently.

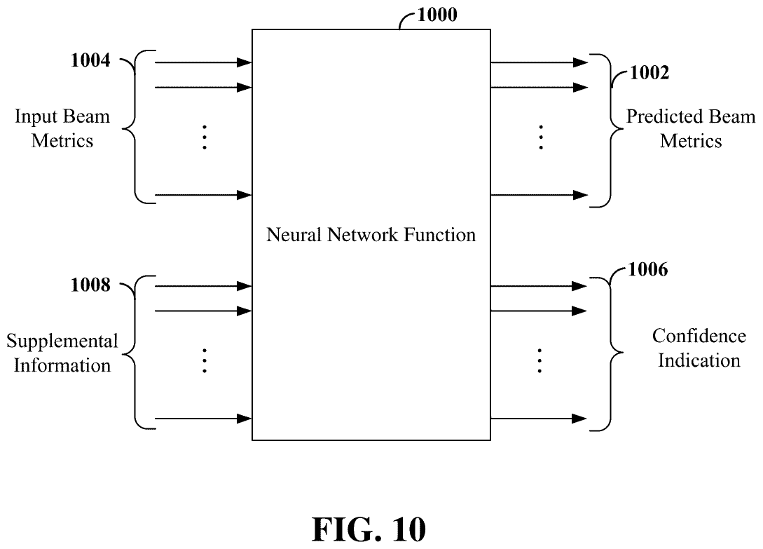

FIG. 10 is a block diagram illustrating a neural network function (NNF) 1000 implementation for beam prediction according to some aspects. In one example, the NNF 1000 may be implemented in the beam prediction model 900 (e.g., in model structure 902). The NNF 1000 can output predicted beam metrics 1002 based on at least in part input beam metrics 1004. Examples of the input beam metrics 1004 may include measured beam metrics (e.g., RSRP, received signal strength indication (RSSI), and/or SINR) of one or more beams. Examples of the output beam metrics 1002 may include predicted beam metrics (e.g., RSRP, RSSI, and/or SINR) of one or more beams, or one or more predicted beam indices. The NNF 1000 may include a plurality of input ports, and each input port can receive beam metrics associated with a particular beam. For example, each input port can be associated with an SSB resource, CSI-RS resource, or a transmission configuration indicator (TCI) state. Each TCI state can contain parameters for determining a quasi co-location (QCL) relationship between downlink reference signals and the DM-RS ports of the PDSCH, the DM-RS port of PDCCH, or the CSI-RS port(s) of a CSI-RS resource. The NNF 1000 may include a plurality of output ports for outputting the predicted beam metrics 1002. Each output port can be associated with an SSB resource, CSI-RS resource, or a TCI state of a predicted beam. In one example, the output ports may provide predicted beam metrics including the RSRP and associated standard deviation of a plurality of SSBs (e.g., SSB IDs 1 to 10).

In some aspects, TCI states are configured for PDCCH, PDSCH, and CSI-RS in order to convey the QCL indication to the associated reference signals. A network entity (e.g., a base station) can configure the TCI states using RRC signaling, and activate the configured TCI state by sending a MAC-CE command to the UE. A TCI state change and corresponding beam switch can be initiated via MAC-CE or DCI. When the TCI state for PDSCH is indicated by DCI, the TCI state change or associated beam switch can be configured via DCI. If the MAC-CE activation command only includes a DL or Joint TCI state and/or an UL TCI state mapped to one TCI codepoint, the UE can apply the TCI state associated with the codepoint to a UE dedicated PDSCH/PDCCH channel (e.g., 3 milliseconds (ms)) after the slot containing the acknowledgment (ACK) for the MAC-CE command. Alternatively, the MAC-CE command may activate multiple TCI states corresponding to multiple TCI codepoints.

In some aspects, a DCI command can select a TCI codepoint from the multiple TCI codepoints activated by MAC-CE. The selected TCI codepoint can take effect after the first slot after a beam application time that is counted from the last symbol containing the ACK to the DCI command. The DCI command may be applied to multiple component carriers (CCs) or bandwidth parts (BWPs). In this case, the first slot when the TCI codepoint selection takes effect and the beam application time may be determined based on the configured BWP with the smallest subcarrier spacing (SCS) of all configured BWP(s) among the carrier(s) applying the beam indication. Alternatively, the first slot when the TCI codepoint selection takes effect and the beam application time, may be both determined based on the active BWP with the smallest SCS of all active BWP(s) among the carrier(s) applying the beam indication.

In some aspects, a list of CSI-RS and SRS resources can be configured for maximum permissible emission (MPE) candidate beam management. In some aspects, only periodic CSI-RS or SRS resources may be included in the list.

In some aspects, a UE may report an index of capability value set associated with a TCI state or CSI-RS resource along with a measurement report (e.g., L1 RSRP or L1 SINR report). For example, the index of capability value set can indicate the maximum number of SRS ports associated with a TCI state or RS resource. In such a report, the bit width of a reported index of capability value set can be determined based on a UE capability report, e.g., a maximum capability number or a total UE reported capability index number. For instance, if the UE reports that a maximum of 4 SRS ports can be supported based on UE capability, then a bit width of 2 bits can be used to report the index of capability value set for the supported SRS port number, for example, “00” for 1 port, “01” for 2 port, “10” for 3 ports, and “11” for 4 ports.

In some aspects, the NNF 1000 can optionally output confidence indication 1006. The confidence indication 1006 can provide information for determining the likelihood or confidence that the predicted beam metrics are correct or useful for predicting a future beam. Examples of the confidence indication 1006 can include the standard deviation (SD) and variance of predicted beam metrics (e.g., RSRPs and/or SINRs), a confidence range of the predicted beam metrics, and/or a failure probability of the predicted beam metrics.

In some aspects, the NNF 1000 may optionally consider supplemental information 1008 for use in beam prediction based on the input beam metrics 1004. The supplemental information 1008 can provide information for interpreting, qualifying, and/or modifying the input beam metrics. Examples of the supplemental information 1008 may include timestamps of beam metrics, types of RSRP measurements (e.g., RSRP by measurement or interpolated), expected error of RSRP measurement (e.g., errors due to interpolation or measurement), etc. In one example, the supplemental information 1008 may provide measurement pattern information of the input metrics (e.g., beam(s) measured in the past), to help the NNF 1000 to evaluate the confidence level of prediction.

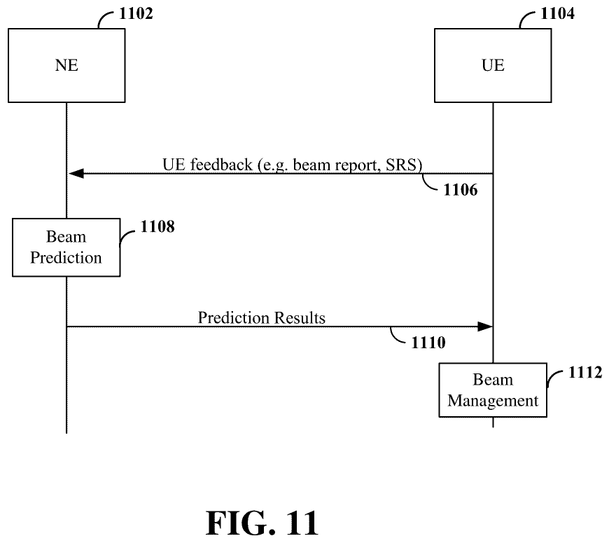

FIG. 11 is a diagram illustrating a first implementation of beam prediction at a network entity according to some aspects. In one example, a network entity 1102 (e.g., a base station or gNB) can be configured to perform beam prediction for communication with a UE 1104 using a beam prediction model. For example, the network entity can use the beam prediction model 900 described above in relation to FIGS. 9 and 10. The network entity can configure the UE 1104 to provide UE feedback or information that can be used for beam predictions at the network entity.

At 1106, the UE can send UE feedback to the network entity. For example, the UE feedback can include a CSI report or a beam report on one or more beams. The report can provide various beam or channel quality information (e.g., RSRP, RSSI, and/or SINR) associated with one or more beams. In some aspects, the UE 1104 may also transmit SRS for UL channel measurement at the network entity for facilitating beam prediction.

At 1108, the network entity 1102 can use a beam prediction model to generate beam prediction results based on at least in part the UE feedback and/or SRS measurements. Running the beam prediction model at the network side allows a power-limited UE (e.g., IoT devices) to benefit from using beam prediction because a power-limited UE may not have sufficient power and/or resources to run the beam prediction model. In some aspects, the beam prediction results can include predicted beam metrics (e.g., the RSRP, RSSI, and/or SINR) of one or more beams that the UE can use in the future for communication with the network entity. In some aspects, the beam prediction results can include the beam index of one or more beams that the UE can use in the future. In some aspects, the prediction results may also include confidence indication (e.g., SD, variance, confidential range, failure probability, etc.) on the predicted beam metrics. At 1112, the UE can perform a beam management procedure based on the prediction results. Using beam prediction to select or change a beam, the UE can reduce the overhead involved in beam and RS measurements and reportings.

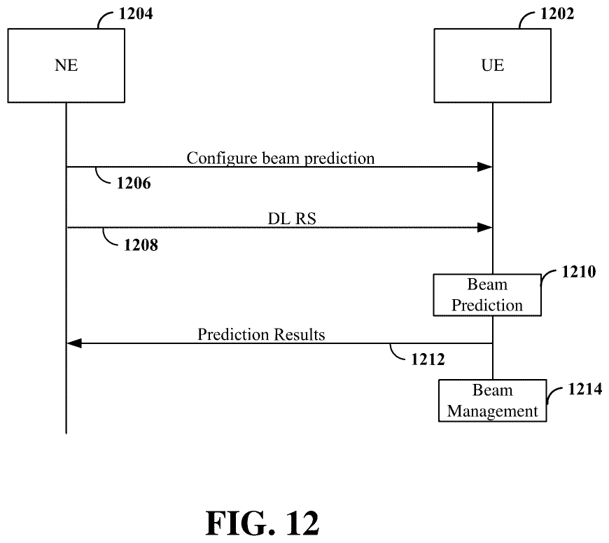

FIG. 12 is a diagram illustrating an implementation beam prediction at a UE according to some aspects. In one example, a UE 1202 can be configured to perform beam prediction using a beam prediction model. A network entity 1204 can configure the UE 1202 to predict one or more future beams or the corresponding beam measurements or metrics using the beam prediction model. For example, the UE 1202 can be configured to use the beam prediction model 900 described above in relation to FIGS. 9 and 10.

At 1206, the network entity 1204 can configure the UE 1202 to use a beam prediction model for predicting one or more future beams for communication between the UE and the network entity 1204. For example, the beam prediction model may be based on a machine learning (ML) model that may a neural network function (e.g., NNF 1000). In one aspect, the network entity can send an RRC message, a MAC-CE, and/or a DCI to indicate the beam prediction model to the UE. The UE may be preconfigured with a plurality of beam prediction models, and the network entity can indicate one of the configured beam prediction models.

At 1208, the network entity 1204 can transmit one or more DL reference signals (e.g., SSB and/or CSI-RS) one or more beams that can be measured by the UE for use in beam prediction using the beam prediction model. For example, the UE can measure the RSRP, RSSI, and/or SINR of one or more beams carrying the DL reference signals. At 1210, the UE 1202 can use the beam prediction model (e.g., beam prediction model 900) configured or indicated by the network entity to generate beam prediction results or metrics based on at least in part the measurements of the DL reference signal 1208. In some aspects, the beam prediction model can consider additional information (e.g., supplemental information 1008) to generate the beam prediction results. The additional information (e.g., interference from other UEs or cells) may include signal measurements available locally at the UE. The beam prediction results may include predicted beam measurements or metrics (e.g., RSRP, RSSI, and/or SINR) and/or one or more predicted beam indices.

At 1212, the UE 1202 can send the beam prediction results to the network entity 1204. For example, the UE can send the beam prediction results in an UL report (e.g., CSI report or a beam report) for one or more beams based on a reporting configuration or triggering condition that is configured by the network entity 1204. In one aspect, the beam prediction results can include various beam or channel quality information (e.g., RSRP, RSSI, and/or SINR) associated with one or more beams that the UE can use in future communication with the network entity. In some aspects, the beam prediction results can include the beam index of one or more beams that the UE can use in the future. In some aspects, the beam prediction results 1212 may also include confidence indication (e.g., SD, variance, confidential range, failure probability, etc.) on the prediction results.

At 1214, the UE 1202 can perform a beam management procedure based on the beam prediction results. Running the beam prediction model at the UE side can provide the beam prediction model with more measurement inputs that may not be available at the network entity. Furthermore, running the beam prediction model at the UE can reduce the UE overhead of sending a CSI report or beam report that may not be needed when the UE can predict future beam measurements or metrics using the beam prediction model.

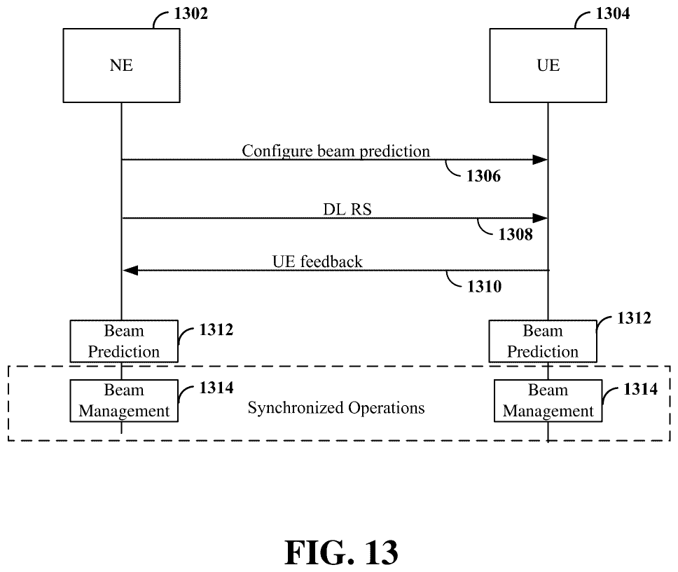

FIG. 13 is a diagram illustrating an implementation of beam prediction at both a UE and a network entity according to some aspects. In this example, a network entity 1302 and a UE 1304 can coordinate to use the same beam prediction model to predict one or more future beams or the corresponding beam metrics. For example, the beam prediction model may be the beam prediction model 900 described above in relation to FIGS. 9 and 10.

At 1306, the network entity 1302 can configure the UE 1304 to use the same beam prediction model for future beam or beam measurements/metrics prediction. In one example, the beam prediction model may be based on a trained ML model using a neural network function (e.g., NNF 1000 of FIG. 10). In one aspect, the network entity send an RRC message, a MAC-CE, and/or a DCI to the UE to indicate the beam prediction model for beam prediction. In some aspects, the UE can be configured with a plurality of beam prediction models, and the network entity can indicate which one of the beam predication models is used for beam prediction.

At 1308, the network entity 1302 can transmit one or more DL reference signals (e.g., SSB and/or CSI-RS) on one or more beams that can be measured by the UE for beam or beam measurements/metrics prediction. For example, the UE can measure the RSRP, RSSI, and/or SINR associated with one or more beams carrying the DL reference signals.

At 1310, the UE 1304 can send UE feedback on the measured beam(s) to the network entity. For example, the UE feedback can include an UL report (e.g., CSI report or a beam report) on one or more beams. The report can provide various beam or channel quality information (e.g., RSRP, RSSI, and/or SINR) associated with one or more beams. In some aspects, the UE 1304 may also transmit UL RS (e.g., SRS) for UL channel measurement at the network entity to facilitate beam prediction.

At 1312, the network entity 1302 and UE 1304 can run the same beam prediction model (e.g., beam prediction model 900) to generate beam prediction results based on at least in part the measurements of the DL reference signal 1308 on one or more beams. For example, the UE can generate the beam prediction results based on local measurements of the DL reference signal 1308, and the network entity 1302 can generate the prediction results based on the UE feedback 1310 including the beam measurements. In one aspect, the beam prediction results can include various beam or channel quality information (e.g., RSRP, RSSI, and/or SINR) associated with one or more beams that the network entity and UE can use in the future. In some aspects, the beam prediction results can include the beam index of one or more beams that can be used in the future. In some aspects, the beam prediction results may also include confidence indication (e.g., SD, variance, confidential range, failure probability, etc.) on the prediction results.

At 1314, the network entity 1302 in synchronization with the UE 1304 can perform a beam management procedure based on the beam prediction results. Running the same beam prediction model at both the network entity and the UE can trigger synchronized beam configuration updates without further signaling between the network entity and the UE. For example, the beam prediction results may indicate a potential beam failure on one or more current beams in the future. In this case, the beam prediction results can trigger both the network entity and the UE to change to a new beam or beams at a predetermined time before the potential beam failure could occur.

In some aspects, a beam prediction model (e.g., beam prediction model 900) can be configured in different modes in various scenarios. In one aspect, when a UE uses a discontinuous reception (DRX) mode to reduce power consumption, the UE may change or reconfigure the beam prediction model to minimize the use of beam prediction, for example, in the DRX-off periods. In one aspect, the UE may change the beam prediction model due to a change of UE mobility. For example, the beam prediction model (e.g., NNF 1000) may be configured to use different parameters for beam prediction based on the speed and/or location of the UE. In one aspect, when beam prediction errors occur constantly or frequently, the network entity/UE may deactivate the beam prediction model, and use other available beam management techniques (e.g., measurement-based beam management) for beam management. In one aspect, when the channel interference level goes up, the beam prediction model can be configured to consider interference (e.g., SINR) during beam prediction.

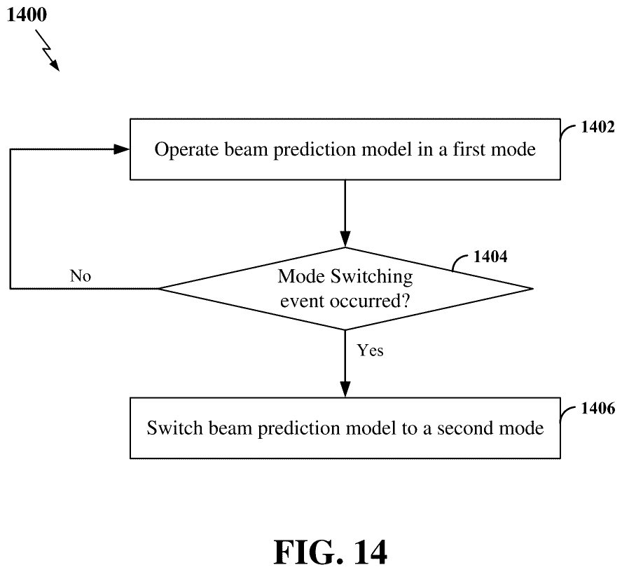

FIG. 14 is a flow chart illustrating an exemplary process 1400 for performing beam prediction according to some aspects of the disclosure. In some examples, the process 1400 may be carried out at a network entity and/or a UE. In some examples, the process 1400 may be carried out by any suitable apparatus or means for carrying out the functions or algorithm described below.

At 1402, an apparatus (e.g., a UE or network entity) can be configured to operate a beam prediction model in a first mode. For example, a network entity (e.g., a gNB) can configure the UE to operate the beam prediction model 900 in the first mode to predict one or more future beams and/or the associated beam measurements/metrics. At 1404, the apparatus can determine whether a beam prediction model mode switching event (hereafter “switching event”) has occurred or not. Some examples of the switching event may be a DRX mode change, a UE mobility change, a prediction error, an interference level change, etc. The apparatus can determine the switching event when one or more of the above changes occurred. If the apparatus determines no switching event has occurred, the apparatus does not switch or change the mode of the beam prediction model. To the contrary, at block 1406, the UE can switch or change the mode of the beam prediction model to a second mode in response to a determination that the switching event has occurred.

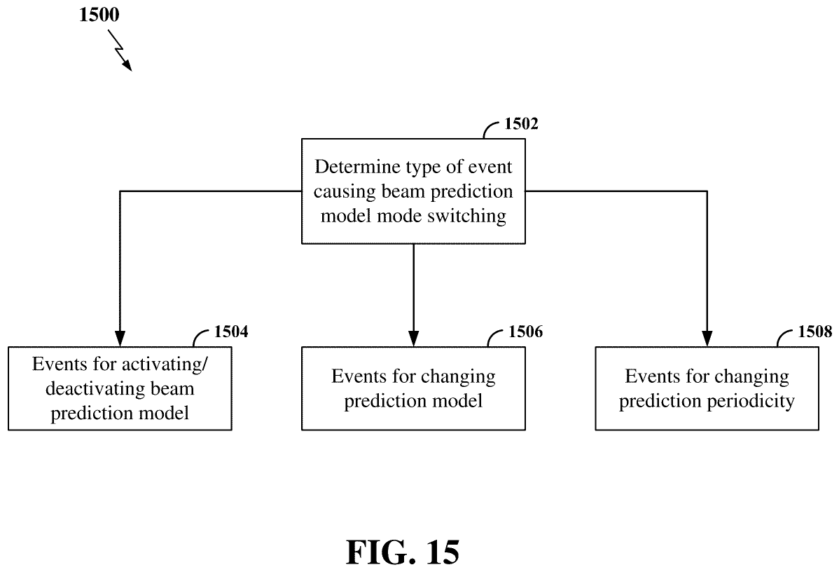

FIG. 15 is a flow chart illustrating an exemplary process 1500 for determining types of events causing a mode switching of a beam prediction model according to some aspects of the disclosure. In some examples, the process 1500 may be carried out by a network entity or a UE as described herein. In some examples, the process 1500 may be carried out by any suitable apparatus or means for carrying out the functions or algorithm described below. In one example, an apparatus (e.g., a network entity or UE) has determined to change the mode of a beam prediction model used for beam prediction as described above in relation to FIG. 14. To that end, at 1502, the apparatus can determine the type of the switching event that triggers beam prediction model mode switching.

At 1504, a first type of switching event can cause the activation or deactivation of a beam prediction model. When the beam prediction model is deactivated, the apparatus (e.g., UE or network entity) may perform beam management using beam measurement-based techniques. In some aspects, the deactivation/activation of the beam prediction model can be performed on a per beam basis (i.e., partial activation/deactivation for a subset of active beams). For example, the UE can activate the beam prediction model for one or more beams and deactivate the beam prediction model for one or more different beams.

At 1506, a second type of event can change the configuration and/or parameters of a beam prediction model used for beam prediction. In one aspect, the apparatus can use the same/different NNF (e.g., NNF 1000) for the beam prediction model but use different input and/or output parameters (e.g., different input/beam parameters). In one aspect, the apparatus can use different periodicities of beam and/or RS measurements as inputs to the beam prediction model (e.g., NNF) depending on the mobility level of the UE. For example, a UE can use a shorter periodicity for beam and/or RS measurements in high mobility scenarios (e.g., UE moving at high speed) and longer periodicity for beam and/or RS measurements in low mobility scenarios (e.g., UE being stationary). In one aspect, the apparatus can include interference prediction (e.g., predicted (SINR) in the outputs of the beam prediction model when the interference in the communication channel is significant. When interference is negligible, the predicted beam metrics (e.g., predicted beam RSRP) may be sufficient for beam prediction. In that case, interference prediction information may not be included as input parameters of the beam prediction model.

At 1508, a third type of event can change the periodicity of the beam prediction model. In one aspect, the apparatus (e.g., a network entity or UE) can operate the same beam prediction model (e.g., a trained ML model) with different periodicities in different scenarios. In one aspect, a UE can operate in a DRX-off mode to reduce power consumption. The UE/network entity can operate the beam prediction model based on the UE's DRX cycle. For example, the UE can use a longer periodicity for the beam prediction model during the DRX-off period, and use a shorter periodicity during the DRX-on period. During the DRX-off period, beam prediction can be performed less frequently.

In some aspects, a network entity can configure the mode switch of a beam prediction model explicitly. For example, the network entity may activate, deactivate, or change the configuration of a beam prediction model via RRC, MAC-CE, and/or DCI signaling. In some aspects, the mode switch can be triggered autonomously or implicitly by a UE report/event. For example, the UE can transmit a report (e.g., a beam/CSI report) that can trigger one of the above-described mode switching events. In one example, a determination of a large prediction error may cause the UE to autonomously deactivate, reconfigure, or change the beam prediction model (e.g., changing NNF, input parameters, and/or output parameters). In one example, the apparatus can deactivate or change the beam prediction model during a DRX-off cycle.

### Prediction Error Event

In one aspect, an apparatus can switch, reconfigure, or change (e.g., activation/deactivation) the mode of a beam prediction model when the beam prediction model outputs a prediction error that meets a predetermined condition. For example, the UE can send an UL report (e.g., CSI report, beam report, or error report) that indicates the prediction error. In one example, the UE can compare the predicted beam metrics (e.g., predicted RSRP) and measured beam metrics (e.g., measured RSRP) to determine the prediction error. In response to a large prediction error, the network entity can configure the UE to deactivate the beam prediction model. In one aspect, the UE can autonomously or implicitly (i.e., without receiving a command from the network entity) deactivate the beam prediction model after sending the report indicating the large prediction error. In one example, the predetermined condition (e.g., large prediction error) can occur when the prediction error is greater than a predetermined threshold (e.g., RSRP or RSSI error threshold) and/or when the prediction error occurred a predetermined number of times or more over a predetermined period (e.g., X or more errors in Y seconds).

Upon the deactivation of the beam prediction model, the UE can use measurement-based techniques for beam management, for example, as described above in relation to FIG. 6. Beam management-related report and reference signal (RS) configurations can be changed or reconfigured after switching the mode of the beam prediction model. Different beam report configurations can configure the UE to include different report contents and/or use different reporting periodicities depending on the mode of the beam prediction model. In one example, when the beam prediction model is activated, the beam report may be configured to include the predicted beam measurements/metrics, beam indices, and/or prediction error. When the beam prediction model is deactivated, the beam report may be configured to include measured beam metrics (e.g., RSRP, RSSI, and SINR). Further, the beam report periodicity may be sparse in time when the beam prediction model is deactivated, relative to the more frequent beam report periodicity when the beam prediction model is activated.

When the beam prediction model is deactivated, the UE may need to send an UL report (e.g., beam/CSI report and/or error report) more frequently when measurement-based techniques are used for beam management. When the beam prediction model is activated, the RS configuration may be configured to use a longer periodicity for DL reference signals (e.g., SSB and CSI-RS), for example, to reduce measurement and reporting overhead at the UE. When the beam prediction model is deactivated, the RS configuration may be configured to use a shorter periodicity for measuring DL reference signals to facilitate beam management.

In some aspects, activation/deactivation of the beam prediction model can be performed on a per beam basis. For example, the UE may report a large prediction error for only a subset of beams (or one or more outputs of the beam prediction model), and the other beams (or outputs of the beam prediction model) do not have a large prediction error. In this case, the trigger event for switching the mode of the beam prediction model can be applied on a per beam/prediction model output basis. In one example, the network entity may receive a report from a UE that indicates a large prediction error for a subset of beams. Then, the network entity can deactivate the beam prediction model for the subset of beams. In this case, the beam prediction model is partially deactivated. In one example, the network entity can send a message (e.g., using RRC, MAC-CE, or DCI) to configure the UE to partially deactivate the beam prediction model. Since the beam prediction model is only partially deactivated, the UE/network entity can still use the beam prediction model for the other beams/outputs that are not deactivated. The apparatus can ignore the deactivated outputs of the beam prediction model. In some aspects, the UE can still monitor the deactivated outputs of the partially deactivated beam prediction model and determine and report the errors (if any) corresponding to those partially deactivated beams/outputs. When the errors of the deactivated beams/outputs fall below a predetermined level, the network entity/UE can reactivate these outputs of the beam prediction model.

In some aspects, the UE can use different beam report configurations and/or RS configurations for the activated beams/outputs and deactivated beams/outputs of the beam prediction model. In one example, the UE can send separate reports for the activated beams and deactivated beams, respectively. For example, the report for the deactivated beam may include measured beam metrics (e.g., measured RSRP and SINR), and the report for the activated beam may include predicted beam metrics (e.g., predicted RSRP and SINR). In some aspects, the UE can send a single report for activated beams and deactivated beams of the beam prediction model. The single report can include measured beam metrics (e.g., measured RSRP, RSSI, SINR) for the deactivated beams, and predicted beam metrics (e.g., predicted RSRP, RSSI, SINR) for the activated beams.

### DRX Configuration Based Event

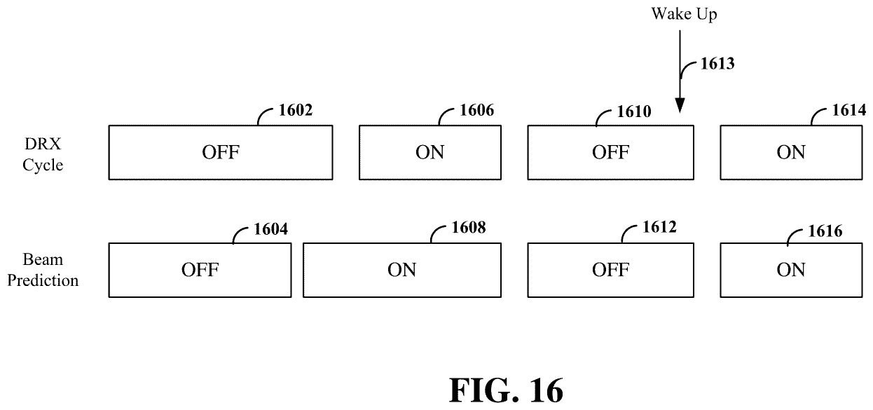

FIG. 16 is a drawing illustrating an example of switching between modes of a beam prediction model based on a DRX configuration. In one aspect, a DRX cycle includes a DRX-on period and a DRX-off period. In the DRX-off period, the UE monitors the DL control channel (e.g., PDCCH) on predefined time durations then goes to sleep to reduce power consumption. A UE can switch between the DRX-on period and DRX-off period according to a DRX configuration that can specify the periodicity, duration, and cycle information of the DRX-on and DRX-off periods. For example, when the UE is in a first DRX-off period 1602, and UE can deactivate, at 1604, the beam prediction model. When the UE deactivates the beam prediction model, the UE can stop sending prediction results (e.g., beam report) and error reports to the network entity in the DRX-off period. In some aspects, the UE can adjust the periodicity of the prediction reports (e.g., beam report and error report) based on the DRX cycle, for example, always-on, micro sleep, deep sleep, etc.

When the UE is still in the first DRX-off period 1602, the UE can activate, at 1608, the beam prediction model in anticipation of an upcoming DRX-on period. In some aspects, the UE can activate the beam prediction model before switching from the DRX-off period 1602 to the DRX-on period 1606 such that the UE can perform beam prediction and reporting prior to entering the DRX-on period. When the UE enters the second DRX-off period 1610, the UE can deactivate, at 1612, the beam prediction model again. In some aspects, the UE can receive a wake-up signal 1613 from the network entity before the default or configured termination time of the second DRX-off period 1610. In this case, the UE can switch to a second DRX-on period 1614 early and, at 1616, activates the beam prediction model.

### Interference Based Event

In some aspects, a baseline or default beam prediction model can be used to predict the future beam metrics without accounting for potential interference from other beams, devices, network entities, and/or cells, as long as the interference level does not cause significant errors in the prediction results. When the interference level goes up, the baseline beam prediction model may not provide a reliable prediction. In some aspects, the UE can switch to measurement-based beam management (i.e., legacy mode). For example, the UE can measure and report interference information (e.g., L1 SINR) to account for the interference during beam management.

In some aspects, interference may be predictable for a certain time, area, and/or beam. In that case, the UE can switch the beam prediction model to an interference-aware beam prediction mode. For example, the network entity can configure the UE to enable interference-aware beam prediction when the UE has interference statistics and/or historical information that help the UE to predict interference using the beam prediction model. In one aspect, the network entity (e.g., gNB) can configure (e.g., by RRC, MAC-CE, DCI) the UE to switch the beam prediction model to an interference-aware mode when the network entity receives an interference report from the UE. In one aspect, the UE can autonomously change the mode of the beam prediction model upon sending the interference report which satisfies a predefined condition (e.g., interference greater than a predetermined threshold).

In some aspects, different beam report configurations and/or reference signal configurations can be configured, depending on whether an apparatus (e.g., UE or network entity) uses measurement-based beam management or interference-aware beam prediction. When a beam report may include measured beam metrics with interference information (e.g., L1-SINR) when the UE uses measurement-based beam management. The report may include predicted beam metrics with predicted interference information (e.g., predicted L1-SINR) and interference statistics when the UE uses an interference-aware beam prediction. In some aspects, a network entity can transmit specific reference signals (e.g., CSI-RS) for interference measurement when the UE uses measurement-based beam management or as inputs to an interference-aware beam prediction model.

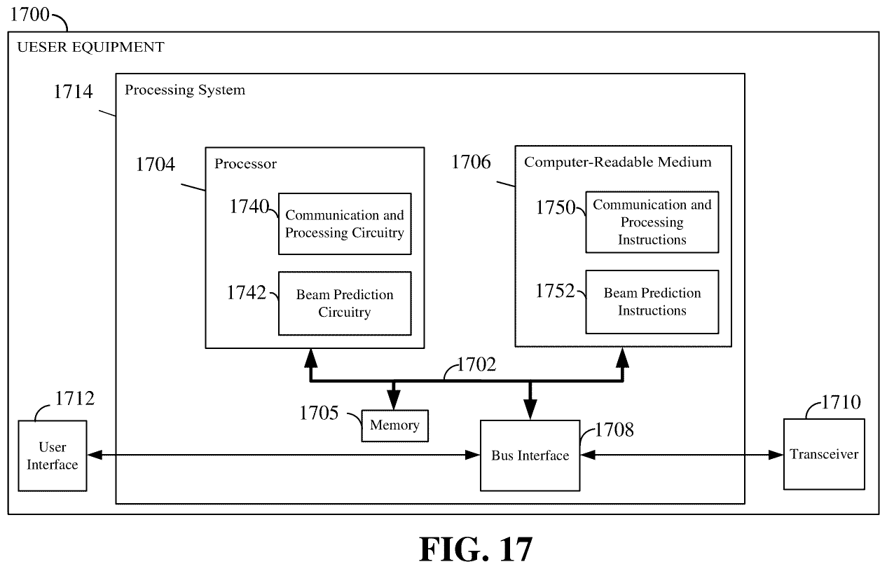

FIG. 17 is a block diagram illustrating an example of a hardware implementation for a UE 1700 employing a processing system 1714. For example, the UE 1700 may be a UE as illustrated in any one or more of FIGS. 1, 2, 3, 6, 8, 11, 12, and/or 13.

The UE 1700 may be implemented with a processing system 1714 that includes one or more processors 1704. Examples of processors 1704 include microprocessors, microcontrollers, digital signal processors (DSPs), field programmable gate arrays (FPGAs), programmable logic devices (PLDs), state machines, gated logic, discrete hardware circuits, and other suitable hardware configured to perform the various functionality described throughout this disclosure. In various examples, the UE 1700 may be configured to perform any one or more of the functions described herein. That is, the processor 1704, as utilized in the UE 1700, may be used to implement any one or more of the processes and procedures described and illustrated herein.

The processor 1704 may in some instances be implemented via a baseband or modem chip and in other implementations, the processor 1704 may include a number of devices distinct and different from a baseband or modem chip (e.g., in such scenarios as may work in concert to achieve examples discussed herein). And as mentioned above, various hardware arrangements and components outside of a baseband modem processor can be used in implementations, including RF-chains, power amplifiers, modulators, buffers, interleavers, adders/summers, etc.

In this example, the processing system 1714 may be implemented with a bus architecture, represented generally by the bus 1702. The bus 1702 may include any number of interconnecting buses and bridges depending on the specific application of the processing system 1714 and the overall design constraints. The bus 1702 communicatively couples together various circuits including one or more processors (represented generally by the processor 1704), a memory 1705, and computer-readable media (represented generally by the computer-readable medium 1706). The bus 1702 may also link various other circuits such as timing sources, peripherals, voltage regulators, and power management circuits, which are well known in the art, and therefore, will not be described any further. A bus interface 1708 provides an interface between the bus 1702 and a transceiver 1710. The transceiver 1710 provides a communication interface or means for communicating with various other apparatus over a transmission medium. Depending upon the nature of the apparatus, a user interface 1712 (e.g., keypad, display, speaker, microphone, joystick, touchscreen) may also be provided. Of course, such a user interface 1712 is optional, and may be omitted in some examples, such as a base station.

The processor 1704 is responsible for managing the bus 1702 and general processing, including the execution of software stored on the computer-readable medium 1706. The software, when executed by the processor 1704, causes the processing system 1714 to perform the various functions described below for any particular apparatus. The computer-readable medium 1706 and the memory 1705 may also be used for storing data that is manipulated by the processor 1704 when executing software.

One or more processors 1704 in the processing system may execute software. Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise. The software may reside on a computer-readable medium 1706. The computer-readable medium 1706 may be a non-transitory computer-readable medium. A non-transitory computer-readable medium includes, by way of example, a magnetic storage device (e.g., hard disk, floppy disk, magnetic strip), an optical disk (e.g., a compact disc (CD) or a digital versatile disc (DVD)), a smart card, a flash memory device (e.g., a card, a stick, or a key drive), a random access memory (RAM), a read only memory (ROM), a programmable ROM (PROM), an erasable PROM (EPROM), an electrically erasable PROM (EEPROM), a register, a removable disk, and any other suitable medium for storing software, code, and/or instructions that may be accessed and read by a computer. The computer-readable medium 1706 may reside in the processing system 1714, external to the processing system 1714, or distributed across multiple entities including the processing system 1714. The computer-readable medium 1706 may be embodied in a computer program product. By way of example, a computer program product may include a computer-readable medium in packaging materials. Those skilled in the art will recognize how best to implement the described functionality presented throughout this disclosure depending on the particular application and the overall design constraints imposed on the overall system.

In some aspects of the disclosure, the processor 1704 may include circuitry configured for various functions, including, for example, communication beam prediction using a beam prediction model. For example, the circuitry may be configured to implement one or more of the functions described herein, for example, in relation to FIGS. 9-16 and 18.

In some aspects of the disclosure, the processor 1704 may include communication and processing circuitry 1740 configured for various functions, including for example communicating with a network entity (e.g., a base station, gNB). In some examples, the communication and processing circuitry 1740 may include one or more hardware components that provide the physical structure that performs processes related to wireless communication (e.g., signal reception and/or signal transmission) and signal processing (e.g., processing a received signal and/or processing a signal for transmission). For example, the communication and processing circuitry 1740 may include one or more transmit/receive chains. In addition, the communication and processing circuitry 1740 may be configured to transmit and process uplink traffic and uplink control messages (e.g., similar to uplink traffic 116 and uplink control 118 of FIG. 1), receive and process downlink traffic and downlink control messages (e.g., similar to downlink traffic 112 and downlink control 114). The communication and processing circuitry 1740 may further be configured to execute communication and processing software 1750 stored on the computer-readable medium 1706 to implement one or more functions described herein.

In some implementations where the communication involves receiving information, the communication and processing circuitry 1740 may obtain information from a component of the UE 1700 (e.g., from the transceiver 1710 that receives the information via radio frequency signaling or some other type of signaling suitable for the applicable communication medium), process (e.g., decode) the information, and output the processed information. For example, the communication and processing circuitry 1740 may output the information to another component of the processor 1704, to the memory 1705, or to the bus interface 1708. In some examples, the communication and processing circuitry 1740 may receive one or more of signals, messages, other information, or any combination thereof. In some examples, the communication and processing circuitry 1740 may receive information via one or more channels. In some examples, the communication and processing circuitry 1740 may include functionality for a means for receiving. In some examples, the communication and processing circuitry 1740 may include functionality for a means for processing, including a means for demodulating, a means for decoding, etc.

In some implementations where the communication involves sending (e.g., transmitting) information, the communication and processing circuitry 1740 may obtain information (e.g., from another component of the processor 1704, the memory 1705, or the bus interface 1708), process (e.g., modulate, encode, etc.) the information, and output the processed information. For example, the communication and processing circuitry 1740 may output the information to the transceiver 1710 (e.g., that transmits the information via radio frequency signaling or some other type of signaling suitable for the applicable communication medium). In some examples, the communication and processing circuitry 1740 may send one or more of signals, messages, other information, or any combination thereof. In some examples, the communication and processing circuitry 1740 may send information via one or more channels. In some examples, the communication and processing circuitry 1740 may include functionality for a means for sending (e.g., a means for transmitting). In some examples, the communication and processing circuitry 1740 may include functionality for a means for generating, including a means for modulating, a means for encoding, etc.

In some aspects of the disclosure, the processor 1704 may include beam prediction circuitry 1742 configured for various functions, including for example beam prediction using a beam prediction model with different modes. In one aspect, the beam prediction circuitry 1742 can be configured to switch between different modes of a beam prediction model (e.g., beam prediction model 900) used for beam prediction. For example, the beam prediction circuitry 1742 can predict future beam and/or interference metrics (e.g., RSRP, RSSI, SINR) of a beam set based on past beam measurements/metrics as described above in relation to FIGS. 9-16. The beam prediction circuitry 1742 can be configured to switch between different modes of the beam prediction model in response to a change of a beam prediction condition that includes, for example, a discontinuous reception (DRX) mode of the UE, a change in UE mobility, a prediction error of the beam prediction model, and/or an interference level.

In some aspects, the beam prediction circuitry 1742 can be configured to activate or deactivate the beam prediction model, reconfigure the beam prediction model from a first mode to a second mode, and/or change a periodicity of operating the beam prediction model. The beam prediction circuitry 1742 may further be configured to execute beam prediction software 1752 stored on the computer-readable medium 1706 to implement one or more functions described herein.

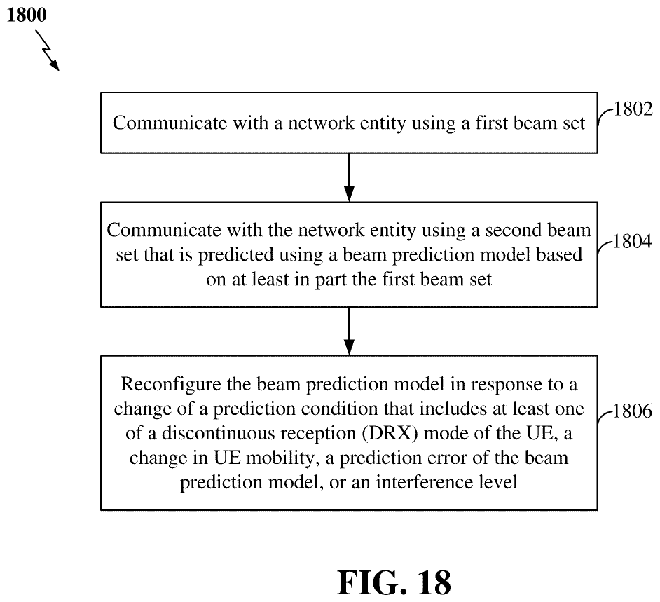

FIG. 18 is a flow chart illustrating an exemplary process 1800 for wireless communication using beam prediction in accordance with some aspects of the present disclosure. As described below, some or all illustrated features may be omitted in a particular implementation within the scope of the present disclosure, and some illustrated features may not be required for implementation of all examples. In some examples, the process 1800 may be carried out by the UE 1700 illustrated in FIG. 17. In some examples, the process 1800 may be carried out by any suitable apparatus or means for carrying out the functions or algorithm described below.

At block 1802, a UE can communicate with a network entity (e.g., a base station, gNB, or CU/DU) using a first beam set. In one aspect, the communication and processing circuitry 1740 can provide a means to communicate with the network entity via the transceiver 1710. The first beam set can include one or more beams/BPLs (e.g., beams 606a-606h and 608a-608e).

At block 1804, the UE can communicate with the network entity using a second beam set that is predicted using a beam prediction model based on at least in part the first beam set. In one aspect, the beam prediction circuitry 1742 can provide a means to predict the second beam set. The first beam set and the second beam set may have the same beams, be overlapped in some beams, or have completely different beams. In one aspect, the beam prediction circuitry 1742 can implement the beam prediction model using software, hardware, or a combination of both. In one example, the beam prediction model may be similar to the beam prediction model 900 described in relation to FIGS. 9 and 10.

At block 1806, the UE can reconfigure or change the beam prediction model in response to a change of a prediction condition that includes at least one of a discontinuous reception (DRX) mode of the UE, a change in UE mobility, a prediction error of the beam prediction model, or an interference level. The beam prediction circuitry 1742 can provide a means to determine the change of prediction condition. In one aspect, changing the beam prediction model can activate or deactivate the beam prediction model. In one aspect, changing the beam prediction model can reconfigure the beam prediction model from a first mode to a second mode. The first mode and the second mode may be different in terms of a prediction function configured to predict one or more future beams or beam metrics. The first mode and the second mode may be different in terms of at least one input parameter (e.g., measurement beam metrics, supplemental information) of the beam prediction model. The first mode and the second mode may be different in terms of at least one output parameter (e.g., predicted beam metrics, confidence indication) of the beam prediction model. In one aspect, changing the beam prediction model can change a periodicity of operating the beam prediction model.

In one aspect, the UE can initiate the changing the beam prediction model based on a command from the network entity in response to the change of the prediction condition. In one aspect, the UE can initiate the changing the beam prediction model autonomously in response to the change of the prediction condition. In one aspect, the UE can deactivate the beam prediction model in response to a beam prediction error greater than a predetermined threshold. In one aspect, the UE can deactivate the beam prediction model in response to the UE being in a DRX-off mode, and activate the beam prediction model in response to the UE being in a DRX-off mode. In one aspect, the UE can activate the beam prediction model in response to receiving a wake-up signal in the DRX-off mode. In one aspect, the UE can change the beam prediction model to an interference-aware mode when the interference level is greater than a predetermined threshold. In one aspect, the UE can change the beam prediction model to a beam measurement-based mode in response to the interference level being greater than a predetermined threshold. In one aspect, the UE can change the beam prediction model to a beam measurement-based mode in response to the change of UE mobility. In one aspect, the UE can change the beam prediction model on a per beam basis. In one aspect, changing the beam prediction model can include changing a beam report configuration and/or a reference signal configuration.

In one configuration, the UE 1700 includes means for switching between different modes of a beam prediction model for wireless communication. In one aspect, the aforementioned means may be the processor(s) 1704 shown in FIG. 17 configured to perform the functions recited by the aforementioned means. In another aspect, the aforementioned means may be a circuit or any apparatus configured to perform the functions recited by the aforementioned means.

Of course, in the above examples, the circuitry included in the processor 1704 is merely provided as an example, and other means for carrying out the described functions may be included within various aspects of the present disclosure, including but not limited to the instructions (e.g., executable code) stored in the computer-readable storage medium 1706, or any other suitable apparatus or means described in any one of the FIGS. 1, 2, 3, 6, 8, 11, 12, and/or 13, and utilizing, for example, the processes and/or algorithms described herein in relation to FIGS. 9-16 and/or 18.

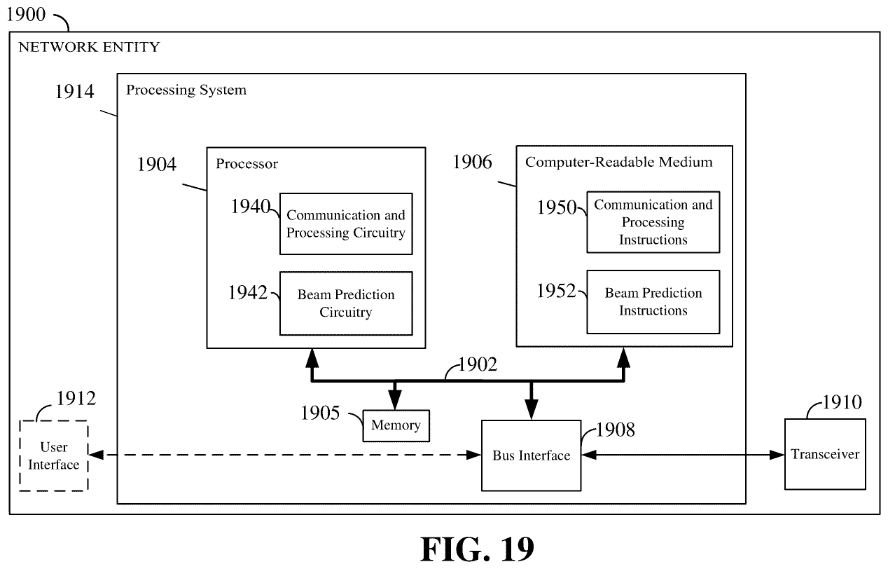

FIG. 19 is a conceptual diagram illustrating an example of a hardware implementation for an exemplary network entity 1900 employing a processing system 1914. In accordance with various aspects of the disclosure, an element, or any portion of an element, or any combination of elements may be implemented with a processing system 1914 that includes one or more processors 1904. For example, the network entity 1900 may be a base station (e.g., gNB, CU, DU) as illustrated in any one or more of FIGS. 1, 2, 3, 6, 8, 11, 12, and/or 13. The network entity 1900 may further be implemented in an aggregated or monolithic base station architecture, or in a disaggregated base station architecture, and may include one or more of a CU, a DU, a RU, a Near-RT RAN RIC, or a Non-RT RIC.

The processing system 1914 may be substantially the same as the processing system 1714 illustrated in FIG. 17, including a bus interface 1908, a bus 1902, memory 1905, a processor 1904, and a computer-readable medium 1906. Furthermore, the network entity 1900 may include a user interface 1912 and a transceiver 1910 substantially similar to those described above in FIG. 17. That is, the processor 1904, as utilized in a network entity 1900, may be used to implement any one or more of the processes described herein and illustrated, for example, in FIGS. 9-16 and 20.

In some aspects of the disclosure, the processor 1704 may include circuitry configured for various functions, including, for example, communication beam prediction using a beam prediction model. For example, the circuitry may be configured to implement one or more of the functions described herein, for example, in relation to FIGS. 9-16 and 20.

In some aspects of the disclosure, the processor 1904 may include communication and processing circuitry 1940 configured for various functions, including for example communicating with a UE or scheduled entity. In some examples, the communication and processing circuitry 1940 may include one or more hardware components that provide the physical structure that performs processes related to wireless communication (e.g., signal reception and/or signal transmission) and signal processing (e.g., processing a received signal and/or processing a signal for transmission). For example, the communication and processing circuitry 1940 may include one or more transmit/receive chains. In addition, the communication and processing circuitry 1940 may be configured to receive and process uplink traffic and uplink control messages (e.g., similar to uplink traffic 116 and uplink control 118 of FIG. 1), transmit and process downlink traffic and downlink control messages (e.g., similar to downlink traffic 112 and downlink control 114). The communication and processing circuitry 1940 may further be configured to execute communication and processing software 1950 stored on the computer-readable medium 1706 to implement one or more functions described herein.

In some implementations where the communication involves receiving information, the communication and processing circuitry 1940 may obtain information from a component of the network entity 1900 (e.g., from the transceiver 1910 that receives the information via radio frequency signaling or some other type of signaling suitable for the applicable communication medium), process (e.g., decode) the information, and output the processed information. For example, the communication and processing circuitry 1940 may output the information to another component of the processor 1904, to the memory 1905, or to the bus interface 1908. In some examples, the communication and processing circuitry 1940 may receive one or more of signals, messages, other information, or any combination thereof. In some examples, the communication and processing circuitry 1940 may receive information via one or more channels. In some examples, the communication and processing circuitry 1940 may include functionality for a means for receiving. In some examples, the communication and processing circuitry 1940 may include functionality for a means for processing, including a means for demodulating, a means for decoding, etc.

In some implementations where the communication involves sending (e.g., transmitting) information, the communication and processing circuitry 1940 may obtain information (e.g., from another component of the processor 1904, the memory 1905, or the bus interface 1908), process (e.g., modulate, encode, etc.) the information, and output the processed information. For example, the communication and processing circuitry 1940 may output the information to the transceiver 1910 (e.g., that transmits the information via radio frequency signaling or some other type of signaling suitable for the applicable communication medium). In some examples, the communication and processing circuitry 1940 may send one or more of signals, messages, other information, or any combination thereof. In some examples, the communication and processing circuitry 1940 may send information via one or more channels. In some examples, the communication and processing circuitry 1940 may include functionality for a means for sending (e.g., a means for transmitting). In some examples, the communication and processing circuitry 1940 may include functionality for a means for generating, including a means for modulating, a means for encoding, etc.

In some aspects of the disclosure, the processor 1904 may include beam prediction circuitry 1942 configured for various functions, including for example beam prediction using different beam prediction models or modes. In one aspect, the beam prediction circuitry 1942 can be configured to perform beam prediction using a beam prediction model (e.g., beam prediction model 900). For example, the beam prediction circuitry 1942 can predict future beam metrics (e.g., RSRP, RSSI, SINR) of a beam set based on past beam measurements or metrics as described above in relation to FIGS. 9-16. The beam prediction circuitry 1942 can be configured to switch between different modes of the beam prediction model in response to a change of a beam prediction condition that includes one or more of a DRX mode of the UE, a change in UE mobility, a prediction error of the beam prediction model, and an interference level.

In some aspects, the beam prediction circuitry 1942 can be configured to activate or deactivate the beam prediction model, reconfigure the beam prediction model from a first mode to a second mode, and/or change a periodicity of operating the beam prediction model. The beam prediction circuitry 1942 may further be configured to execute beam prediction software 1952 stored on the computer-readable medium 1906 to implement one or more functions described herein.

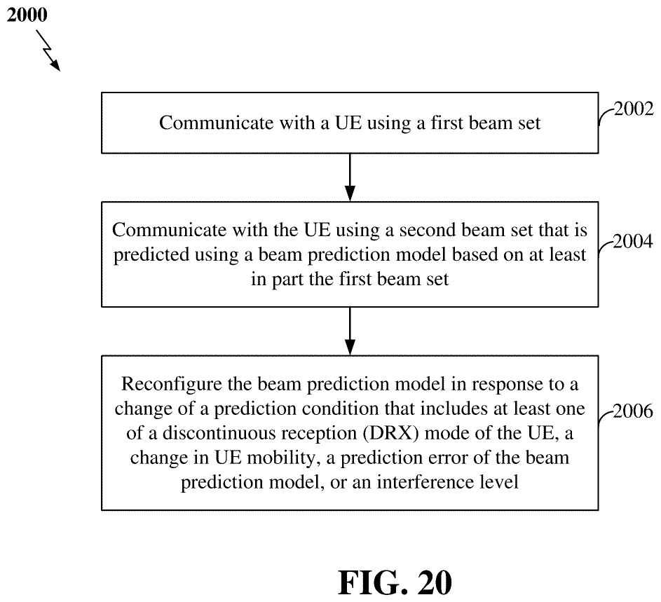

FIG. 20 is a flow chart illustrating an exemplary process 2000 for wireless communication using beam prediction in accordance with some aspects of the present disclosure. As described below, some or all illustrated features may be omitted in a particular implementation within the scope of the present disclosure, and some illustrated features may not be required for implementation of all examples. In some examples, the process 2000 may be carried out by the network entity 1900 illustrated in FIG. 19. In some examples, the process 2000 may be carried out by any suitable apparatus or means for carrying out the functions or algorithm described below.

At block 2002, a network entity can communicate with a UE using a first beam set. In one aspect, the communication and processing circuitry 2040 can provide a means to communicate with the UE directly or via another network entity. The first beam set can include one or more beams/BPLs (e.g., beams 606a-606h and 608a-608e).

At block 2004, the network entity can communicate with the UE using a second beam set that is predicted using a beam prediction model based on at least in part the first beam set. In one aspect, the beam prediction circuitry 1942 can provide a means to predict the second beam set. The first beam set and the second beam set may have the same beams, be overlapped in some beams, or have completely different beams. In one aspect, the beam prediction circuitry 1942 can implement the beam prediction model using software, hardware, or a combination of both. In one example, the beam prediction model may be similar to the beam prediction model 900 described in relation to FIGS. 9 and 10.

At block 2006, the network entity can change or reconfigure the beam prediction model in response to a change of a prediction condition that includes at least one of a discontinuous reception (DRX) mode of the UE, a change in UE mobility, a prediction error of the beam prediction model, or an interference level. The beam prediction circuitry 1942 can provide a means to determine the change of prediction condition. In one aspect, changing the beam prediction model can activate or deactivate the beam prediction model. In one aspect, changing the beam prediction model can reconfigure the beam prediction model from a first mode to a second mode. The first mode and the second mode may be different in terms of a prediction function configured to predict one or more future beams or beams metrics. The first mode and the second mode may be different in terms of at least one input parameter (e.g., measurement beam metrics, supplemental information) of the beam prediction model. The first mode and the second mode may be different in terms of at least one output parameter (e.g., predicted beam metrics, confidence indication) of the beam prediction model. In one aspect, changing the beam prediction model can change a periodicity of operating the beam prediction model.

In one aspect, the network entity can initiate the changing the beam prediction model by sending a command to the UE in response to the change of the prediction condition. In one aspect, the network entity can initiate the changing the beam prediction model in synchronization with the UE in response to the change of the prediction condition. In one aspect, the network entity can deactivate the beam prediction model in response to a beam prediction error greater than a predetermined threshold. In one aspect, the network entity can deactivate the beam prediction model in response to the UE being in a DRX-off mode, and activate the beam prediction model in response to the UE being in a DRX-off mode. In one aspect, the network entity can change the beam prediction model to an interference-aware mode when the interference level is greater than a predetermined threshold. In one aspect, the network entity can change the beam prediction model to a beam measurement-based mode in response to the interference level being greater than a predetermined threshold. In one aspect, the network entity can change the beam prediction model to a beam measurement-based mode in response to a change of UE mobility. In one aspect, the network entity can change the beam prediction model on a per beam basis. In one aspect, changing the beam prediction model can include changing a beam report configuration and/or a reference signal configuration.

In one configuration, the network entity 1900 includes means for switching between different modes of a beam prediction model for wireless communication. In one aspect, the aforementioned means may be the processor(s) 1904 shown in FIG. 19 configured to perform the functions recited by the aforementioned means. In another aspect, the aforementioned means may be a circuit or any apparatus configured to perform the functions recited by the aforementioned means.

Of course, in the above examples, the circuitry included in the processor 1904 is merely provided as an example, and other means for carrying out the described functions may be included within various aspects of the present disclosure, including but not limited to the instructions (e.g., executable code) stored in the computer-readable storage medium 1906, or any other suitable apparatus or means described in any one of the FIGS. 1, 2, 3, 6, 8, 11, 12, and/or 13, and utilizing, for example, the processes and/or algorithms described herein in relation to FIGS. 9-16 and/or 20.

In a first aspect, a method of wireless communication at a user equipment (UE) is provided. The method includes: communicating with a network entity using a first beam set; communicating with the network entity using a second beam set that is predicted using a beam prediction model based on at least in part the first beam set; and reconfiguring the beam prediction model in response to a change of a prediction condition that comprises at least one of a discontinuous reception (DRX) mode of the UE, a change in UE mobility, a prediction error of the beam prediction model, or an interference level.

In a second aspect, alone or in combination with the first aspect, wherein the reconfiguring the beam prediction model comprises at least one of: activating or deactivating the beam prediction model; changing the beam prediction model from a first mode to a second mode; or changing a periodicity of operating the beam prediction model.

In a third aspect, alone or in combination with the second aspect, wherein the first mode and the second mode are different in terms of, at least one of: a prediction function configured to predict one or more beams; at least one input parameter of the beam prediction model; or at least one output parameter of the beam prediction model.

In a fourth aspect, alone or in combination with any of the first to third aspects, wherein the reconfiguring the beam prediction model comprises: initiating reconfiguration of the beam prediction model based on a command from the network entity in response to the change of the prediction condition.

In a fifth aspect, alone or in combination with any of the first to third aspects, wherein the reconfiguring the beam prediction model comprises: initiating reconfiguration of the beam prediction model autonomously in response to sending a report to the network entity, the report indicating the change of the prediction condition.

In a sixth aspect, alone or in combination with any of the first to third aspects, wherein the reconfiguring the beam prediction model comprises: deactivating the beam prediction model in response to a beam prediction error greater than a predetermined threshold.

In a seventh aspect, alone or in combination with any of the first to third aspects, wherein the reconfiguring the beam prediction model comprises: deactivating the beam prediction model in response to the UE being in a DRX-off mode; and activating the beam prediction model in response to the UE being in a DRX-off mode.

In an eighth aspect, alone or in combination with the seventh aspect, wherein the reconfiguring the beam prediction model further comprises: activating the beam prediction model in response to receiving a wake up signal in the DRX-off mode.

In a ninth aspect, alone or in combination with any of the first to third aspects, wherein the reconfiguring the beam prediction model comprises: changing the beam prediction model to an interference-aware mode when the interference level is greater than a predetermined threshold.

In a tenth aspect, alone or in combination with any of the first to third aspects, wherein the reconfiguring the beam prediction model comprises: changing the beam prediction model to a beam measurement-based mode in response to the interference level being greater than a predetermined threshold.

In an eleventh aspect, alone or in combination with any of the first to third aspects, wherein the reconfiguring the beam prediction model comprises: changing the beam prediction model to a beam measurement-based mode in response to the change of UE mobility.

In a twelfth aspect, alone or in combination with any of the first to third aspects, wherein the reconfiguring the beam prediction model comprises: changing the beam prediction model on a per beam basis.

In a thirteenth aspect, alone or in combination with any of the first to third aspects, wherein the reconfiguring the beam prediction model comprises at least one of: selecting a beam report configuration among a plurality of beam report configurations that are different in terms of at least one of report content or report periodicity; or selecting a reference signal configuration among a plurality of reference signal configurations that are different in terms of reference signal periodicity.

In a fourteenth aspect, a user equipment (UE) for wireless communication is provided. The UE comprises: a transceiver for communication with a network entity; a processor; and a memory coupled to the processor, the memory comprising instructions executable by the processor to cause the UE to: communicate with the network entity using a first beam set; communicate with the network entity using a second beam set that is predicted using a beam prediction model based on at least in part the first beam set; and reconfigure the beam prediction model in response to a change of a prediction condition that comprises at least one of a discontinuous reception (DRX) mode of the UE, a change in UE mobility, a prediction error of the beam prediction model, or an interference level.

In a fifteenth aspect, alone or in combination with the fourteenth aspect, wherein, to reconfigure the beam prediction model, the instructions further cause the UE to at least one of: activate or deactivate the beam prediction model; change the beam prediction model from a first mode to a second mode; or change a periodicity of operating the beam prediction model.

In a sixteenth aspect, alone or in combination with the fifteenth aspect, wherein the first mode and the second mode are different in terms of, at least one of: a prediction function configured to predict one or more beams; at least one input parameter of the beam prediction model; or at least one output parameter of the beam prediction model.

In a seventh aspect, alone or in combination with any of the fourteenth to sixteen aspects, wherein, to reconfigure the beam prediction model, the instructions further cause the UE to: initiate reconfiguration of the beam prediction model based on a command from the network entity in response to the change of the prediction condition.

In an eighteenth aspect, alone or in combination with any of the fourteenth to sixteen aspects, wherein, to reconfigure the beam prediction model, the instructions further cause the UE to: initiate reconfiguration of the beam prediction model autonomously in response to sending a report to the network entity, the report indicating the change of the prediction condition.

In a nineteenth aspect, alone or in combination with any of the fourteenth to sixteen aspects, wherein, to reconfigure the beam prediction model, the instructions further cause the UE to: deactivate the beam prediction model in response to a beam prediction error greater than a predetermined threshold.

In a twentieth aspect, alone or in combination with any of the fourteenth to sixteen aspects, wherein, to reconfigure the beam prediction model, the instructions further cause the UE to: deactivate the beam prediction model in response to the UE being in a DRX-off mode; and activate the beam prediction model in response to the UE being in a DRX-off mode.

In a twenty-first aspect, alone or in combination with the twentieth aspect, wherein, to reconfigure the beam prediction model, the instructions further cause the UE to: activate the beam prediction model in response to receiving a wake up signal in the DRX-off mode.

In a twenty-second aspect, alone or in combination with any of the fourteenth to sixteen aspects, wherein, to reconfigure the beam prediction model, the instructions further cause the UE to: change the beam prediction model to an interference-aware mode when the interference level is greater than a predetermined threshold.

In a twenty-third aspect, alone or in combination with any of the fourteenth to sixteen aspects, wherein, to reconfigure the beam prediction model, the instructions further cause the UE to: change the beam prediction model to a beam measurement-based mode in response to the interference level being greater than a predetermined threshold.

In a twenty-fourth aspect, alone or in combination with any of the fourteenth to sixteen aspects, wherein, to reconfigure the beam prediction model, the instructions further cause the UE to: change the beam prediction model to a beam measurement-based mode in response to the change of UE mobility.

In a twenty-fifth aspect, alone or in combination with any of the fourteenth to sixteen aspects, wherein, to reconfigure the beam prediction model, the instructions further cause the UE to: change the beam prediction model on a per beam basis.

In a twenty-sixth aspect, alone or in combination with any of the fourteenth to sixteen aspects, wherein, to reconfigure the beam prediction model, the instructions further cause the UE to at least one of: select a beam report configuration among a plurality of beam report configurations that are different in terms of at least one of report content or report periodicity; or select a reference signal configuration among a plurality of reference signal configurations that are different in terms of reference signal periodicity.

In a twenty-seventh aspect, a user equipment (UE) for wireless communication is provided. The UE comprises: means for communicating with a network entity using a first beam set; means for communicating with the network entity using a second beam set that is predicted using a beam prediction model based on at least in part the first beam set; and means for reconfiguring the beam prediction model in response to a change of a prediction condition that comprises at least one of a discontinuous reception (DRX) mode of the UE, a change in UE mobility, a prediction error of the beam prediction model, or an interference level.

In a twenty-eighth aspect, a computer-readable storage medium stored with executable code for wireless communication is provided. The executable code comprises instructions that cause a user equipment (UE) to: communicate with a network entity using a first beam set; communicate with the network entity using a second beam set that is predicted using a beam prediction model based on at least in part the first beam set; and reconfigure the beam prediction model in response to a change of a prediction condition that comprises at least one of a discontinuous reception (DRX) mode of the UE, a change in UE mobility, a prediction error of the beam prediction model, or an interference level.

In a twenty-ninth aspect, a method of wireless communication at a network entity is provided. The method comprises: communicating with a user equipment (UE) using a first beam set; communicating with the UE using a second beam set that is predicted using a beam prediction model based on at least in part the first beam set; and reconfiguring the beam prediction model in response to a change of a prediction condition that comprises at least one of a discontinuous reception (DRX) mode of the UE, a change in UE mobility, a prediction error of the beam prediction model, or an interference level.

In a thirtieth aspect, alone or in combination with the twenty-ninth aspect, wherein the reconfiguring the beam prediction model comprises at least one of: activating or deactivating the beam prediction model; changing the beam prediction model from a first mode to a second mode; or changing a periodicity of operating the beam prediction model.

In a thirty-first aspect, alone or in combination with the thirtieth aspect, wherein the first mode and the second mode are different in terms of, at least one of: a prediction function configured to predict one or more beam; at least one input parameter of the beam prediction model; or at least one output parameter of the beam prediction model.

In a thirty-second aspect, alone or in combination with any of the twenty-ninth to thirty-first aspects, wherein the reconfiguring the beam prediction model comprises: sending a command to initiate reconfiguration of the beam prediction model in response to a report from the UE, the report indicating the change of the prediction condition.

In a thirty-third aspect, alone or in combination with any of the twenty-ninth to thirty-first aspects, wherein the reconfiguring the beam prediction model comprises: changing the beam prediction model in synchronization with the UE in response to the change of the prediction condition.

In a thirty-fourth aspect, alone or in combination with any of the twenty-ninth to thirty-first aspects, wherein the reconfiguring the beam prediction model comprises: deactivating the beam prediction model in response to a beam prediction error greater than a predetermined threshold.

In a thirty-fifth aspect, alone or in combination with any of the twenty-ninth to thirty-first aspects, wherein the reconfiguring the beam prediction model comprises: deactivating the beam prediction model in response to the UE being in a DRX-off mode; and activating the beam prediction model in response to the UE being in a DRX-off mode.

In a thirty-sixth aspect, alone or in combination with the thirty-fifth aspect, wherein the reconfiguring the beam prediction model further comprises: sending a wake up signal to activate the beam prediction model at the UE in the DRX-off mode.

In a thirty-seventh aspect, alone or in combination with any of the twenty-ninth to thirty-first aspects, wherein the reconfiguring the beam prediction model comprises: changing the beam prediction model to an interference-aware mode when the interference level is greater than a predetermined threshold.

In a thirty-eighth aspect, alone or in combination with any of the twenty-ninth to thirty-first aspects, wherein the reconfiguring the beam prediction model comprises: changing the beam prediction model to a beam measurement-based mode in response to the interference level being greater than a predetermined threshold.

In a thirty-ninth aspect, alone or in combination with any of the twenty-ninth to thirty-first aspects, wherein the reconfiguring the beam prediction model comprises: changing the beam prediction model to a beam measurement-based mode in response to the change of UE mobility.

In a fortieth aspect, alone or in combination with any of the twenty-ninth to thirty-first aspects, wherein the reconfiguring the beam prediction model comprises: changing the beam prediction model on a per beam basis.

In a forty-first aspect, alone or in combination with any of the twenty-ninth to thirty-first aspects, wherein the reconfiguring the beam prediction model comprises at least one of: selecting a beam report configuration among a plurality of beam report configurations that are different in terms of at least one of report content or report periodicity; or selecting a reference signal configuration among a plurality of reference signal configurations that are different in terms of reference signal periodicity.

In a forty-second aspect, a network entity of a wireless communication network is provided. The network entity comprises: a processor; and a memory coupled to the processor, memory comprising instructions executable by the processor to cause the network entity to: communicate with a user equipment (UE) using a first beam set; communicate with the UE using a second beam set that is predicted using a beam prediction model based on at least in part the first beam set; and reconfigure the beam prediction model in response to a change of a prediction condition that comprises at least one of a discontinuous reception (DRX) mode of the UE, a change in UE mobility, a prediction error of the beam prediction model, or an interference level.

In a forty-third aspect, alone or in combination with the forty-second aspect, wherein, to reconfigure the beam prediction model, the instructions further cause the network entity to at least one of: activate or deactivate the beam prediction model; change the beam prediction model from a first mode to a second mode; or change a periodicity of operating the beam prediction model.

In a forty-fourth aspect, alone or in combination with the forty-third aspect, wherein the first mode and the second mode are different in terms of, at least one of: A prediction function configured to predict one or more beam; at least one input parameter of the beam prediction model; or at least one output parameter of the beam prediction model.

In a forty-fifth aspect, alone or in combination with any of the forty-second to forty-fourth aspects, wherein, to reconfigure the beam prediction model, the instructions further cause the network entity to: send a command to initiate reconfiguration of the beam prediction model in response to a report from the UE, the report indicating the change of the prediction condition.

In a forty-sixth aspect, alone or in combination with any of the forty-second to forty-fourth aspects, wherein, to reconfigure the beam prediction model, the instructions further cause the network entity to: change the beam prediction model in synchronization with the UE in response to the change of the prediction condition.

In a forty-seventh aspect, alone or in combination with any of the forty-second to forty-fourth aspects, wherein, to reconfigure the beam prediction model, the instructions further cause the network entity to: deactivate the beam prediction model in response to a beam prediction error greater than a predetermined threshold.

In a forty-eighth aspect, alone or in combination with any of the forty-second to forty-fourth aspects, wherein, to reconfigure the beam prediction model, the instructions further cause the network entity to: deactivate the beam prediction model in response to the UE being in a DRX-off mode; and activate the beam prediction model in response to the UE being in a DRX-off mode.

In a forty-ninth aspect, alone or in combination with the forty-eighth aspect, wherein, to reconfigure the beam prediction model, the instructions further cause the network entity to: send a wake up signal to activate the beam prediction model at the UE in the DRX-off mode.

In a fiftieth aspect, alone or in combination with any of the forty-second to forty-fourth aspects, wherein, to reconfigure the beam prediction model, the instructions further cause the network entity to: change the beam prediction model to an interference-aware mode when the interference level is greater than a predetermined threshold.

In a fifty-first aspect, alone or in combination with any of the forty-second to forty-fourth aspects, wherein, to reconfigure the beam prediction model, the instructions further cause the network entity to: change the beam prediction model to a beam measurement-based mode in response to the interference level being greater than a predetermined threshold.

In a fifty-second aspect, alone or in combination with any of the forty-second to forty-fourth aspects, wherein, to reconfigure the beam prediction model, the instructions further cause the network entity to: change the beam prediction model to a beam measurement-based mode in response to the change of UE mobility.

In a fifty-third aspect, alone or in combination with any of the forty-second to forty-fourth aspects, wherein, to reconfigure the beam prediction model, the instructions further cause the network entity to: change the beam prediction model on a per beam basis.

In a fifty-fourth aspect, alone or in combination with any of the forty-second to forty-fourth aspects, wherein, to reconfigure the beam prediction model, the instructions further cause the network entity to at least one of: select a beam report configuration among a plurality of beam report configurations that are different in terms of at least one of report content or report periodicity; or select a reference signal configuration among a plurality of reference signal configurations that are different in terms of reference signal periodicity.

In a fifty-fifth aspect, a network entity of a wireless communication network is provided. The network entity comprises: means for communicating with a user equipment (UE) using a first beam set; means for communicating with the UE using a second beam set that is predicted using a beam prediction model based on at least in part the first beam set; and means for reconfiguring the beam prediction model in response to a change of a prediction condition that comprises at least one of a discontinuous reception (DRX) mode of the UE, a change in UE mobility, a prediction error of the beam prediction model, or an interference level.

In a fifty-sixth aspect, a computer-readable storage medium stored with executable code for wireless communication is provided. The executable code comprises instructions that cause a network entity to: communicate with a user equipment (UE) using a first beam set; communicate with the UE using a second beam set that is predicted using a beam prediction model based on at least in part the first beam set; and reconfigure the beam prediction model in response to a change of a prediction condition that comprises at least one of a discontinuous reception (DRX) mode of the UE, a change in UE mobility, a prediction error of the beam prediction model, or an interference level.

Several aspects of a wireless communication network have been presented with reference to an exemplary implementation. As those skilled in the art will readily appreciate, various aspects described throughout this disclosure may be extended to other telecommunication systems, network architectures and communication standards.

By way of example, various aspects may be implemented within other systems defined by 3GPP, such as Long-Term Evolution (LTE), the Evolved Packet System (EPS), the Universal Mobile Telecommunication System (UMTS), and/or the Global System for Mobile (GSM). Various aspects may also be extended to systems defined by the 3rd Generation Partnership Project 2 (3GPP2), such as CDMA2000 and/or Evolution-Data Optimized (EV-DO). Other examples may be implemented within systems employing IEEE 802.11 (Wi-Fi), IEEE 802.16 (WiMAX), IEEE 802.20, Ultra-Wideband (UWB), Bluetooth, and/or other suitable systems. The actual telecommunication standard, network architecture, and/or communication standard employed will depend on the specific application and the overall design constraints imposed on the system.

Within the present disclosure, the word “exemplary” is used to mean “serving as an example, instance, or illustration.” Any implementation or aspect described herein as “exemplary” is not necessarily to be construed as preferred or advantageous over other aspects of the disclosure. Likewise, the term “aspects” does not require that all aspects of the disclosure include the discussed feature, advantage or mode of operation. The term “coupled” is used herein to refer to the direct or indirect coupling between two objects. For example, if object A physically touches object B, and object B touches object C, then objects A and C may still be considered coupled to one another—even if they do not directly physically touch each other. For instance, a first object may be coupled to a second object even though the first object is never directly physically in contact with the second object. The terms “circuit” and “circuitry” are used broadly, and intended to include both hardware implementations of electrical devices and conductors that, when connected and configured, enable the performance of the functions described in the present disclosure, without limitation as to the type of electronic circuits, as well as software implementations of information and instructions that, when executed by a processor, enable the performance of the functions described in the present disclosure.

One or more of the components, steps, features and/or functions illustrated in FIGS. 1-20 may be rearranged and/or combined into a single component, step, feature or function or embodied in several components, steps, or functions. Additional elements, components, steps, and/or functions may also be added without departing from novel features disclosed herein. The apparatus, devices, and/or components illustrated in FIGS. 1-20 may be configured to perform one or more of the methods, features, or steps described herein. The novel algorithms described herein may also be efficiently implemented in software and/or embedded in hardware.

It is to be understood that the specific order or hierarchy of steps in the methods disclosed is an illustration of exemplary processes. Based upon design preferences, it is understood that the specific order or hierarchy of steps in the methods may be rearranged. The accompanying method claims present elements of the various steps in a sample order, and are not meant to be limited to the specific order or hierarchy presented unless specifically recited therein.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but are to be accorded the full scope consistent with the language of the claims, wherein reference to an element in the singular is not intended to mean “one and only one” unless specifically so stated, but rather “one or more.” Unless specifically stated otherwise, the term “some” refers to one or more. A phrase referring to “at least one of” a list of items refers to any combination of those items, including single members. As an example, “at least one of: a, b, or c” is intended to cover: a; b; c; a and b; a and c; b and c; and a, b and c. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

1-13. (canceled)

14. A user equipment (UE) for wireless communication, comprising:
one or more processors; and
one or more memories coupled to the one or more processors; the one or more memories comprising instructions executable by the one or more processors to cause the UE to:
communicate with a network entity using a first beam set;
communicate with the network entity using a second beam set that is predicted using a beam prediction model based on at least in part the first beam set; and
reconfigure the beam prediction model in response to a change of a prediction condition that comprises at least one of a discontinuous reception (DRX) mode of the UE, a change in UE mobility, a prediction error of the beam prediction model, or an interference level.

15. The UE of claim 14, wherein, to reconfigure the beam prediction model, the instructions further cause the UE to at least one of:
activate or deactivate the beam prediction model;
change the beam prediction model from a first mode to a second mode; or
change a periodicity of operating the beam prediction model.

16. The UE of claim 15, wherein the first mode and the second mode are different in terms of, at least one of:
a prediction function configured to predict one or more beams;
at least one input parameter of the beam prediction model; or
at least one output parameter of the beam prediction model.

17. The UE of claim 14, wherein, to reconfigure the beam prediction model, the instructions further cause the UE to:
initiate reconfiguration of the beam prediction model based on a command from the network entity in response to the change of the prediction condition.

18. The UE of claim 14, wherein, to reconfigure the beam prediction model, the instructions further cause the UE to:
initiate reconfiguration of the beam prediction model autonomously in response to sending a report to the network entity, the report indicating the change of the prediction condition.

19. The UE of claim 14, wherein, to reconfigure the beam prediction model, the instructions further cause the UE to:
deactivate the beam prediction model in response to a beam prediction error greater than a predetermined threshold.

20. The UE of claim 14, wherein, to reconfigure the beam prediction model, the instructions further cause the UE to:
deactivate the beam prediction model in response to the UE being in a DRX-off mode; and
activate the beam prediction model in response to the UE being in a DRX-off mode.

21. The UE of claim 20, wherein, to reconfigure the beam prediction model, the instructions further cause the UE to:
activate the beam prediction model in response to receiving a wake up signal in the DRX-off mode.

22. The UE of claim 14, wherein, to reconfigure the beam prediction model, the instructions further cause the UE to:
change the beam prediction model to an interference-aware mode when the interference level is greater than a predetermined threshold;
change the beam prediction model to a beam measurement-based mode in response to the interference level being greater than a predetermined threshold;
change the beam prediction model to a beam measurement-based mode in response to the change of UE mobility; or
change the beam prediction model on a per beam basis.

23-26. (canceled)

27. A user equipment (UE) for wireless communication, comprising:
means for communicating with a network entity using a first beam set;
means for communicating with the network entity using a second beam set that is predicted using a beam prediction model based on at least in part the first beam set; and
means for reconfiguring the beam prediction model in response to a change of a prediction condition that comprises at least one of a discontinuous reception (DRX) mode of the UE, a change in UE mobility, a prediction error of the beam prediction model, or an interference level.

28-41. (canceled)

42. A network entity of a wireless communication network, comprising:
one or more processors; and
one or more memories coupled to the one or more processors, the one or more memories comprising instructions executable by the one or more processors to cause the network entity to:
communicate with a user equipment (UE) using a first beam set;
communicate with the UE using a second beam set that is predicted using a beam prediction model based on at least in part the first beam set; and
reconfigure the beam prediction model in response to a change of a prediction condition that comprises at least one of a discontinuous reception (DRX) mode of the UE, a change in UE mobility, a prediction error of the beam prediction model, or an interference level.

43. The network entity of claim 42, wherein, to reconfigure the beam prediction model, the instructions further cause the network entity to at least one of:
activate or deactivate the beam prediction model;
change the beam prediction model from a first mode to a second mode; or
change a periodicity of operating the beam prediction model.

44. The network entity of claim 43, wherein the first mode and the second mode are different in terms of, at least one of:
a prediction function configured to predict one or more beam;
at least one input parameter of the beam prediction model; or
at least one output parameter of the beam prediction model.

45. The network entity of claim 42, wherein, to reconfigure the beam prediction model, the instructions further cause the network entity to:
send a command to initiate reconfiguration of the beam prediction model in response to a report from the UE, the report indicating the change of the prediction condition.

46. The network entity of claim 42, wherein, to reconfigure the beam prediction model, the instructions further cause the network entity to:
change the beam prediction model in synchronization with the UE in response to the change of the prediction condition.

47. The network entity of claim 42, wherein, to reconfigure the beam prediction model, the instructions further cause the network entity to:
deactivate the beam prediction model in response to a beam prediction error greater than a predetermined threshold.

48. The network entity of claim 42, wherein, to reconfigure the beam prediction model, the instructions further cause the network entity to:
deactivate the beam prediction model in response to the UE being in a DRX-off mode; and
activate the beam prediction model in response to the UE being in a DRX-off mode.

49. The network entity of claim 48, wherein, to reconfigure the beam prediction model, the instructions further cause the network entity to:
send a wake up signal to activate the beam prediction model at the UE in the DRX-off mode.

50. The network entity of claim 42, wherein, to reconfigure the beam prediction model, the instructions further cause the network entity to:
change the beam prediction model to an interference-aware mode when the interference level is greater than a predetermined threshold.

51. The network entity of claim 42, wherein, to reconfigure the beam prediction model, the instructions further cause the network entity to:
change the beam prediction model to a beam measurement-based mode in response to the interference level being greater than a predetermined threshold.

52-56. (canceled)
